(19) United States
(12) Patent Application Publication
(10) Pub. No.: US 2019/0001860 A1
(43) Pub. Date: Jan. 3, 2019

(54) METHOD FOR STACKING A VEHICLE ON TOP OF ANOTHER, SIMILAR VEHICLE, AND STACKABLE VEHICLE FOR CARRYING OUT SAID METHOD

(71) Applicants: Ferry PRONELLO, Ciudad Autónoma de Buenos Aires (AR); Heriberto Antonio PRONELLO, Ciudad Autónoma de Buenos Aires (AR)

(72) Inventor: Heriberto Antonio PRONELLO, Ciudad Autónoma de Buenos Aires (AR)

(21) Appl. No.: 16/063,189

(22) PCT Filed: Dec. 16, 2016
(86) PCT No.: PCT/IB2016/057740

§ 371 Date: Jun. 15, 2018

(30) Foreign Application Priority Data
Dec. 17, 2015 (AR) 20150104129

(51) Int. Cl. B60P 3/08; B60P 3/07; B60P 1/43; B62D 47/00; B60P 7/06; B64D 1/08

(52) U.S. Cl. CPC B60P 3/08; B60P 3/07; B64D 1/08; B62D 47/006; B60P 7/06; B60P 1/43

(57) ABSTRACT

The invention refers to a method for stacking a first motor vehicle on top of a second motor vehicle, comprising the steps of providing a set of rear ramps at the rear part of the lower vehicle, said rear ramps linking the rear part of the roof of the cabin of the lower vehicle, to the ground; providing a set of front ramps or supports in the front part of the roof of the cabin of the lower vehicle, said set of front ramps or supports being such that the front wheels of the upper vehicle, can roll over the same; rolling the upper vehicle on said rear ramps of the lower vehicle so that the upper vehicle ascends or climbs from a position on the ground to a position on top of the roof of the lower vehicle; continue rolling said upper vehicle over the roof of the lower vehicle until it reaches a final stack position, indicated by a stopping means, in which the front wheels of the upper vehicle rest upon the front ramps or supports of the lower vehicle, the rear wheels of the upper vehicle rest upon the rear ramps of the lower vehicle, where the upper vehicle and lower vehicle are substantially vertically aligned, and where the front wheels and rear wheels of the upper vehicle in final rest position are in a lower height than the height of the roof of the lower vehicle; securing the upper vehicle to the lower vehicle by suitable fastening means, where the fastening force of the fastening means preferably is such that the suspensions of the upper vehicle are compressed by about 3 to 5 cm, thus reducing the overall height of the vehicle stack; and, removing, folding or retracting part of or the entirety of the rear ramps of the lower vehicle.

Additionally, the invention refers to a vehicle that can carry out said stacking method, which comprises a vehicle body comprising four wheels and a roofed cabin, a pair of front ramps or supports located at both sides of the front end of the roof of the cabin and a pair of rear ramps located at both sides of the rear end of the roof of the cabin. The stackable vehicle further comprises means for rapid aerial deployment (airdrop) of vehicles transported in a stack in a transport aircraft.

### FIELD OF THE INVENTION

The present invention is related to a method for stacking a vehicle on top of another, similar vehicle, and a stackable vehicle useful for carrying on said method. More specifically, the method of the present invention refers to a method for stacking an all-terrain vehicle intended for security forces and rescue operations on top of another identical or similar vehicle in such a way that the total height is less than the sum of the height of each vehicle, for subsequent transport within a transport aircraft, a container, or for storage. The present invention also relates to an all-terrain vehicle intended for security forces and rescue operations that can be stacked on top of another identical or similar vehicle according the method of the present invention but without compromising the performance and comfort of the vehicle, and without a substantial increment in weight and/or substantial addition of auxiliary elements that do not contribute to the utility of the vehicle during normal operation. Said all-terrain vehicle of the present invention further comprise means allowing a stack of two vehicles of the present invention to be aerially deployed (airdropped).

### BACKGROUND OF THE INVENTION

All-terrain vehicles are widely known and are used in a great number of applications due to their capability of transporting equipment and personnel on terrains and conditions not suited for other conventional vehicles. Particularly, this type of vehicles are useful for use by security forces, such as in combat operations; as transport for troops and equipment; as weapon platforms and in humanitarian or rescue operations, among others.

Occasionally, in some particular operations, it is advantageous or necessary to have an all-terrain vehicle on demand as fast and efficiently as possible. These operations may require receiving, mobilizing, relocating and/or dispatching all-terrain vehicles, as necessary, with varying degrees of urgency. This may be for example a combat situation, a rescue, or an emergency operation, etc. However, it is possible that said operations need to be performed in regions which are inaccessible by conventional means, regions with limited or difficult access. It could also happen that the urgency of the situation is such that conventional transport of the vehicles, such as transport by land or by sea or simply driving them to their destination, is unsuitable. In this situation, the most viable solution for deployment of said vehicles is by means of aerial transport and delivery.

The aerial transport of vehicles, whether for civilian or military use, is widely known in the art and is generally performed using a conventional aerial cargo vehicle, such as a transport plane, adapted to contain and secure a cargo of one or more vehicles within. The use of cargo helicopters for transporting vehicles, which are transported hung under the helicopter, secured by fixing hooks, is also known. Conventionally, in aerial transport by plane, a plurality of vehicles are loaded within the cargo compartment in one or more rows, one behind the other, according to available space. In the case of transporting civilian motor vehicles, it is possible to provide auxiliary structures that allow stacking two vehicles, one on top of the other, thus allowing transport of a greater number of vehicles by surface area of the cargo compartment. This type of stacked transport with auxiliary structures is adequate for the commercial transport of civilian vehicles, or of vehicles in general in which the time and effort required for loading and unloading them is not a concern.

However, in the field of rapid-response operations such as military or emergency operations, the speed and ease with which said vehicles can be loaded and unloaded in their respective transports, and the resources and equipment needed to put them in operative conditions, are of utmost importance. The auxiliary equipment and tools needed for loading, stacking, securing and later unstacking and disembarking the vehicles hinder their rapid deployment, and require carrying external equipment and/or tools. Additionally, all-terrain military vehicles such as the HMMWV “Humvee” are considerably bulkier than civilian vehicles, which limits the amount of units which can be transported and deployed from a single transport aircraft.

Another typical issue associated with the transport of motor vehicles is that they are relatively light equipment per unit volume, and consequently, per unit area. This means that, whether it be in the cargo compartment of a transport vehicle, in a container, or another loading means, conventional transport of vehicles is inefficient in regards to the maximum cargo weight and volume of the transport means used. A transport plane or a cargo container, which comprises a determined cargo surface, a determined cargo volume and a maximum cargo weight, which is loaded with motor vehicles in a conventional manner quickly saturates its available cargo surface without reaching the maximum cargo weight it can transport.

This inefficiency in the use of the maximum cargo capacity in transport vehicles is also found in the temporal or permanent storage of vehicles. The storage of multiple vehicles in a conventional manner is relatively inefficient in relation to the weight per unit area used, compared to the storage of other equipment and goods. The efficiency in the storage of equipment and supplies is particularly critical in risk operations or protected zones, such as for military forces or security operations.

There exists a need to find a technical solution that allows for maximizing the amount of all-terrain vehicles that can be transported by a single transport aircraft (e.g. an airplane), container or other transport means, as well as the amount of vehicles that can be stored per unit area, preferably with as minimum amount of auxiliary equipment and tools required as possible.

In the art, there have been many proposed methods for stacking vehicles which are designed specifically to be stacked over another identical or similar vehicle.

One of such proposals is the VLEGA Gaucho vehicle (Vehiculo Liviano de Empleo General Aerotransportable in Spanish), a military joint development between Argentina and Brazil. Said vehicle comprises a design that allows for a Gaucho vehicle to be stacked over another Gaucho vehicle, resting over the reinforced fenders of the lower vehicle, oriented in the opposite direction. This is achieved by providing a pair or removable ramps that link the front fenders of the lower vehicle with the ground, and providing a pair of removable platforms that connect the front and rear fenders of the lower vehicle together. This way, the upper vehicle can be driven to climb said ramps and roll on said platforms until it reaches a final position over the lower vehicle, resting its wheels over the fenders of said lower vehicle. At this point the vehicles are secured by suitable fixing means, the ramps are removed, and the two vehicles are stacked and ready for transport in a conventional transport plane.

However, despite the fact that the VLEGA Gaucho provides a solution for a stackable and air-transportable all-terrain vehicle, the design of the vehicle and the stacking method are such that said stacking capability comes with the sacrifice of performance and effectiveness of the same as a military or emergency vehicle.

Particularly, the stacking method requires the upper vehicle to roll over platforms placed over the fenders of the lower vehicle. This means that the width of the cabin of the lower vehicle is limited by the transversal spacing between the wheels of the upper vehicle. Likewise, the height of the cabin of the lower vehicle is limited by the height of the floor of the upper vehicle in relation to the contact point of the wheels of the upper vehicle on the fenders of the lower vehicle. This results in a disproportionally wide vehicle, but with a reduced cabin compared to the cabins usually found on vehicles of such width. Regarding its height, the seats for the driver and navigator inside the cabin must be located in a much lower position thereby reducing the visibility by the occupants.

Some later versions of the VLEGA Gaucho tried to address this problem by presenting a more elevated, but removable cabin. This however implies a structure with fixing means, a mounting and dismounting process with the corresponding tools, which negatively affects the response time upon sanitary or security emergencies and reduces the protection to the crew.

Additionally, the fenders of the VLEGA Gaucho must be reinforced to support the total weight of the upper vehicle, which increases the total weight of the vehicle, without providing any benefits to the security and rigidness of the same during operation. Additionally, said removable ramps and platforms for the stacking and unstacking maneuvers are voluminous, must be removed for the normal operation of the vehicle and, when transported with the same, will take up considerable space.

Furthermore, this stacking method interferes with the placement of certain elements in the vehicle, such as the rear-view mirrors, air intakes, exhausts, etc. Said elements are usually found on the sides of the cabin, or at a side of the pillars of the cabin, which hinders the stacking process. As a result, in the design of the vehicle, said elements must be relocated so that they are not an obstacle, or must be disassembled, folded or retracted during stacking and reassembled once again during operation. Said disassembling components and the suitable tools required for assembly/disassembly must be transported together with the vehicle.

The patent application US 2010/0052273 A1 of American Growler, published on Mar. 4, 2010 describes a military vehicle that can be stacked over another similar'vehicle for transport. The vehicle comprises a removable roll cage and a foldable roof, allowing for a greater reduction of the combined height, for transport in aerial transport vehicles such as the V-22 Osprey. Unlike the VLEGA Gaucho previously mentioned, during the stacking process the upper vehicle is deposited onto the lower vehicle by external elevation means, instead of rolling on the side fenders of the lower vehicle. In this way, together with the foldable roof, the width of the cabin is not limited. Additionally, since the roll cage is removable during the stacking, it also doesn't suffer cabin height limitations. However, this design presents a cabin open to the environment, with little protection for the occupants and does not present options for an armored cabin. Additionally, the stacking and unstacking of the vehicles requires external elevation equipment such as cranes or hoists, which, when unavailable at the unstacking site, must also be transported along with the vehicle.

The patent application US 2011/0014003 A1 of Int Truck Intellectual Prop Co., published on Jan. 20, 2011 describes an armored military vehicle which has the capacity to be stacked over another identical vehicle. Unlike the VLEGA Gaucho previously mentioned, during the stacking process the upper armored vehicle does not roll on the lower armored vehicle, but instead is deposited onto the same by suitable external elevation means. The upper vehicle rests on reinforced support points on the roof of the lower vehicle and in the lower face of the upper vehicle. However, similarly to the military vehicle described in US 2010/002273 A1, the stacking and unstacking of the vehicles requires external elevation equipment, which limits its utility.

Therefore, there exists a need for a technical solution for efficiently transporting all-terrain vehicles, either inside a transport aircraft such as an airplane, in cargo containers or in similar means, as well as efficiently storing all-terrain vehicles in storage facilities and parking lots. Said technical solution must provide a vehicle capable of being stacked and unstacked over an identical or similar vehicle with minimal effort and time requirements, and without the need for auxiliary tools and equipment, without compromising the performance and comfort of the same, and without a substantial increment in weight and/or auxiliary elements that do not contribute to the utility of the vehicle during normal operation.

However, often times situations may arise in which deployment of troops, equipment, vehicles, supplies etc. transported by air is required but in which landing a transport plane or planes carrying said goods to unload the goods conventionally is unfeasible or impossible. This might be because landing the plane on location is dangerous, because the area of the operation lacks suitable landing terrain, because the need is too urgent to allow for the time required to land the plane and unload the goods conventionally, or because the goods are required in multiple locations or spread over an area, among other reasons. In any of these situations, such as for example combat operations or urgent rescue operations, it may be necessary to deploy troops, equipment, vehicles, supplies etc. from a transport plane without landing the plane, via what is usually known as an airdrop.

An airdrop implies the aerial delivery of troops, equipment, vehicles, supplies etc. by dropping them from an aircraft over an operation area, with or without breaking aid such a parachute. Airdrops of supplies, and more particularly vehicles, are well known in the art, including successful airdrops of not only motor vehicles such as cars or trucks but also armored combat vehicles and light tanks such as the M2 Bradley. Generally, a vehicle to be airdropped from a transport plane must be specially prepared for an airdrop. Vehicles to be dropped are usually placed on and secured to a platform, and the vehicle rolls off the cargo hold of the transport plane upon aerial deployment. As the vehicle drops, one or more breaking systems such as parachutes will slow the vehicle down to a safe speed until landing. Once the vehicle is on the ground, the parachutes and the restrains securing the vehicle to the platform are removed, leaving the vehicle in operative conditions.

Unfortunately, while this standard approach is effective for aerial deployment of individual vehicles, it is unfeasible for use with vehicles transported in a stack, and therefore suffers from the same inefficient use of the maximum cargo capacity of a transport plane as previously described. Without a means for separating two stacked vehicles inside the plane before the drop or in the air during the drop, the breaking system or parachutes needs to be large enough to slow down the fall of the two vehicles combined, at the risk of damaging or destroying both vehicles should the breaking system fail. Also, most stackable vehicles in the art, such as the ones mentioned above, require external tools, often times large machines such as cranes, for the unstacking process, which most likely will not be available on the airdrop location. Airdropping, by its very nature, isn't particularly precise, and since most stackable vehicles known in the art cannot be operated while stacked, they cannot be driven from the landing location to a location where said tools or machines needed for the unstacking operation are available. Even if said tools or machines are readily available, the time required to place said stackable vehicles in operative conditions is relatively long, which goes against the urgent nature of this type of deployment.

Therefore, there also exists a need for a further technical solution for an efficient and rapid aerial deployment, or airdrop, of all-terrain vehicles transported inside a transport plane in stacked configuration, for applications in which landing the transport plane for conventional unloading of the stacked vehicles is unfeasible or impossible. Said technical solution must provide means to rapidly deploy vehicles which are being aerially transported in stacked configuration, with minimal effort, time and auxiliary equipment requirements, while also minimizing the time required to place the vehicle in operational condition after landing.

### BRIEF DESCRIPTION OF THE INVENTION

In regards to the technical solution previously discussed, it is an object of the present invention to provide a method for stacking a vehicle, preferable an all-terrain vehicle with applications in security forces and rescue operations, on top of another identical or similar vehicle for transport in an aircraft, which does not compromise the performance of the same during normal operation, does not include additional structural reinforcements that increase the weight of the vehicle, does not sacrifice space nor comfort in the cabin, does not require external or auxiliary tools or equipment for the stacking and unstacking process, and does not require the use of a vehicle with distorted or unconventional proportions, the method comprising the steps of
providing a set of rear ramps on a rear part of the first vehicle, linking a rear part of the roof of the cabin of the same with the ground, said rear ramps allowing the wheels of the second vehicle to roll on the them;
providing a set of front ramps on a front part of the roof of the first vehicle, said front ramps allowing the wheels of the second vehicle to roll and be supported by them;
rolling the second vehicle, oriented with the same or inverted orientation as the first vehicle, on said rear ramps so that it ascends from a position on the ground until it reaches the roof of the first vehicle;
continue the movement of the second vehicle on the roof of the first vehicle until it reaches a final position in which the front or rear wheels of the second vehicle, depending on whether the vehicles have the same or inverted orientation, are supported by the front ramps of the first vehicle, and the rear or front wheels of the second vehicle, depending on whether the vehicles have the same or inverted orientation, are supported by the rear ramps of the first vehicle, the final position of the wheels of the second vehicle resting at a height that is lower than the height of the roof of the first vehicle so that the total height of the second vehicle stacked on top of the first vehicle is lower than the sum of the individual heights of the first and second vehicles;
securing the second vehicle to the first vehicle by a fastening means; and
removing, folding, or collapsing part or the entirety of the rear ramps of the first vehicle.

In a preferred embodiment of the present invention, in said final position the fast vehicle and the second vehicle are substantially vertically aligned.

In a preferred embodiment of the present invention, the second vehicle comprises suspensions and the fastening means partially compresses the suspensions of the second vehicle, reducing the total height of the vehicle stack.

In a preferred embodiment of the present invention, said final position of the second vehicle is determined by stopping means.

In a preferred embodiment of the present invention, the vehicle body of the first vehicle has an inner frontal structure and the front ramps rest upon resistant points in the frontal structure of the first vehicle.

In a preferred embodiment of the present invention, the front ramps and the rear ramps are integral to the first vehicle.

It is also an object of the present invention to provide a stackable vehicle for stacking on top of another identical or similar vehicle, for use with the method of the present invention, the vehicle comprising:
a vehicle body having an inner structure, a floor, four wheels, a roofed cabin;
a pair of rear ramps, which extend rearward, located at both sides of a rear end of the roof of the cabin; and
a pair of front ramps, which extend forward, located at both sides of a front end of the roof of the cabin.

In a preferred embodiment of the present invention, the rear ramps are foldable ramps that can adopt at least a folded position and a deployed position, and when on deployed position the rear ramps rest upon the ground behind the vehicle.

In a preferred embodiment of the present invention, the front ramps or supports are foldable ramps that can adopt at least a folded position and a deployed position, and when on deployed position the front ramps rest upon resistant points of inner structure of the vehicle.

In a preferred embodiment of the present invention, the rear ramps each comprise a fixed part and a moving part, the fixed part of the rear ramps each having a rear end and a front end, the front ends of the fixed parts of the rear ramps being located at a rear end of the roof of the cabin of the vehicle and the rear ends of the fixed parts of the rear ramps are located at a rear end of the vehicle, thus linking the rear end of the roof of the cabin to the rear end of the vehicle, and the moving parts of the rear ramps are movingly connected to the rear ends of the corresponding fixed parts of the rear ramps.

In a preferred embodiment of the present invention, at least a portion of the pair of rear ramps, or at least a portion of the pair of front ramps are removable.

In a preferred embodiment of the present invention, the vehicle comprises an upper stopping and fastening means located on an upper part of the roof of the cabin, for securing a vehicle stacked on top of it, and a lower stopping and fastening means located on an external part of the floor of the vehicle for securing a vehicle stacked underneath it.

In a preferred embodiment of the present invention, the lower stopping and fastening means comprises a transversal rod.

In a preferred embodiment of the present invention, the upper stopping and fastening means comprises a hook type mechanism, actuated either automatically or by hand through a lever mechanism.

In a preferred embodiment of the present invention, the upper stopping and fastening means comprise a bolt and nut system on an upper part of the roof of the cabin of the vehicle, actuated either automatically or by hand through a swivel mechanism.

In a preferred embodiment of the present invention, the roof of the cabin is curved and convex.

In a preferred embodiment of the present invention, the roof of the cabin is faceted and convex with descending angles on a front and a rear end.

In a preferred embodiment of the present invention, the floor of the vehicle is curved and concave.

In a preferred embodiment of the present invention, the roof of the cabin comprises two depressed or stepped regions or strips located one on each side of the roof, which run the entire length of the roof, for rolling the wheels of a second vehicle during a stacking operation, said depressed or stepped regions or strips being aligned with the front ramps and the rear ramps.

In a preferred embodiment of the present invention, the roof of the cabin comprises a pair of tubular structures, one on each side of the roof and running the length of the same, delimiting side regions aligned with the front ramps or supports and the rear ramps, for guiding the movement of the wheels of a second vehicle during a stacking operation.

In a preferred embodiment of the present invention, the vehicle further comprises:
a deployable slowing device, for slowing down a falling vehicle to a safe landing speed, having two front slings and at least one rear sling;
two front fastening points located on the front of the vehicle; and
a rear fastening point located behind the cabin of the vehicle;
each of the two front slings of the foldable slowing device being secured to a respective front fastening point, and the at least one rear sling is connected to the rear fastening point.

In a preferred embodiment of the present invention, the deployable slowing device comprises at least one parachute.

In a preferred embodiment of the present invention, the lower stopping and fastening means of the vehicle comprises:
a fixed end piece, secured to the floor of the vehicle;
a transversal rod or pin having a first end, a second ends and an inner spring, the rod being connected by the first end to said fixed end piece by means of a ball-and-socket joint;
a mobile end piece, secured to the floor of the vehicle, connected to a lever and having a transversal hole;
a spring, connecting an end of the lever to floor of the vehicle and applying force to said lever; and
a cable, connecting said end of the lever to said rear fastening point through a pulley system;

the mobile end piece being able to adopt at least a vertical position and at least an angled position;

the inner spring of the rod keeping the rod parallel to the floor of the vehicle when no external force is applied to the rod;

the force of the spring acting on the lever keeping the mobile end piece in vertical position;

the second end of the rod being able to engage with the transversal hole of the mobile end piece when the mobile end piece is in vertical position; so that

a pulling force greater than the force of the spring applied on the rear fastening point causes the cable to pull on the lever causing it to rotate thereby causing the mobile end piece connected to the lever to rotate from the vertical position to the angled position; and

a force applied to the rod that exceeds the force of the inner spring of the rod while the mobile end piece is in angled position causes the rod to rotate about the ball-and-socket joint of its first end.

### BRIEF DESCRIPTION OF THE FIGURES

FIG. 1 is a perspective view of the stackable vehicle according to a preferred embodiment of the invention, showing its front and rear ramps in a retracted position.

FIG. 2 is a perspective view of the stackable vehicle according to a preferred embodiment of the invention, showing its front and rear ramps in a deployed position.

FIG. 3 is a perspective view of the stackable vehicle according to a preferred embodiment of the invention showing the movement of the front and rear ramps.

FIG. 4 is a side view of an in-progress stacking operation of two stackable vehicles according to a preferred embodiment of the present invention.

FIG. 5 is a front view of an in-progress stacking operation of two stackable vehicles according to a preferred embodiment of the present invention.

FIG. 6 is a perspective view of two stackable vehicles in accordance with a preferred embodiment of present invention in final sticking position.

FIG. 7 is a side view of two stackable vehicles according to a preferred embodiment of the present invention in final stacking position.

FIG. 8 is a front view of two stackable vehicles according to a preferred embodiment of the present invention in final stacking position.

FIG. 9 is a perspective view of two stackable vehicles according to a preferred embodiment of the present invention, in final stacking position, in which the vehicles are oriented in opposing directions.

FIG. 10 is a front cross-section view of two stackable vehicles according to a preferred embodiment of the present invention, in final stacking position, showing the transversal profile of the roof of the lower vehicle.

FIG. 11 is a bottom perspective view and detail of the securing rod of the stopping and fastening means of the stackable vehicle according to a preferred embodiment of the present invention.

FIG. 12 is a top perspective view and detail of the hooking mechanism of the stopping and fastening means of the stackable vehicle according to a preferred embodiment of the present invention.

FIG. 13 is a side view of the operation of the stopping and fastening means according to a preferred embodiment of the present invention, in open position.

FIG. 14 is a side view of the operation of the stopping and fastening means according to preferred embodiment of the present invention, in closed position.

FIG. 15 is a front perspective view of the stackable vehicle for rapid aerial deployment according to another embodiment of the invention, showing a parachute in folded configuration, stored on the rear of the vehicle.

FIG. 16 is a rear perspective view of the stackable vehicle for rapid aerial deployment according to another embodiment of the invention, showing a parachute in folded configuration, stored on the rear of the vehicle.

FIG. 17 is a rear perspective view and detail of the stackable vehicle for rapid aerial deployment according to another embodiment of the invention, without the parachute.

FIG. 18 is a rear perspective view and detail of two stackable vehicles for rapid aerial deployment according to another embodiment of the invention, in final stacked position.

FIGS. 19A to 19C show the working steps of the rapid release means of the stackable vehicle for rapid aerial deployment according to another embodiment of the invention.

### DETAILED DESCRIPTION OF THE INVENTION

It is an object of the present invention to provide a stacking method for stacking motor vehicles. It is another object of the present invention to provide a stackable vehicle that can be stacked on top of another identical or similar vehicle in accordance with the stacking method of the present invention. A further objective of the invention is to provide a means for rapid aerial deployment of stacked vehicles of the present invention transported by a transport plane.

The method for stacking vehicles of the present invention is a method for stacking two vehicles, one on top of the other, said two vehicles being a first vehicle, also referred to as the “lower vehicle”, and a second vehicle, also referred to as the “upper vehicle”. In said method, the upper vehicle ascends or climbs over the lower vehicle by means of ramps until it reaches the roof of the lower vehicle, and then rolls on said roof until it reaches a final stacking position. The result of the stacking method of the present invention, in which the upper vehicle rests in final stacking position on top of the lower vehicle, is referred to as a “stack” or “vehicle stack”. The procedure for carrying out the stacking method of the present invention may be referred to as the “stacking operation”. Likewise, the procedure for unstacking a stack of vehicles or reversing the method of the present invention may be referred to as the “unstacking operation”.

The method for stacking vehicles of the present invention is such that it allows using a vehicle design without reduced performance and/or comfort, since by rolling the upper vehicle on the roof of the lower vehicle, the dimensions of the cabin, and consequently the vehicle itself, are not limited by the dimensions of the upper vehicle and more specifically, by the space between the wheels and the height of the floor of said vehicle. Thus, the stacking method of the present invention allows for stacking vehicles with a cabin design suitable for its performance needs without limitations and without negatively affecting its stacking capability, being limited only by the maximum load dimensions of the aerial transport vehicle or container in which it is to be transported.

In the stacking method of the present invention, when the vehicles are in final stacking position, most of the weight of the upper vehicle will be supported by the structure of the cabin of the lower vehicle, in contrast to the designs known in the art such as the VLEGA Gaucho previously mentioned, in which the weight of the upper vehicle rests mostly upon the fenders of the lower vehicle, which must be reinforced with heavy and rigid strictures. Also, in the method of the present invention, when the vehicles are in final stack position, the total height of the stack is considerably lower than the sum of the individual height of each vehicle. This is because in the stacking method of the present invention, maximum use of the available volume is achieved through efficient interlocking of the geometry of both vehicles.

The resulting vehicle stack can then be efficiently loaded in the cargo compartment of a cargo vehicle, such as an AC130 transport airplane, in cargo containers such as the High Cube container, or it can be stored in a storage warehouse or a parking lot. By means of the stacking method of the present invention, the efficiency in transport and/or storage of vehicles is doubled in terms of equipment weight per square meter in relation to conventional methods for transporting and storing vehicles.

The method for stacking vehicles and the stackable vehicle of the present invention will now be described in detail, with reference to the accompanying drawings. To the effects of the present invention and for a better understanding of the Figures, numerical references of components or elements of the stackable vehicle without letters, such as for example “(2)” make general reference to elements that can be bound indistinctly on the upper vehicle and/or the lower vehicle, while numerical references followed by a letter, such as for example “(2A)” make specific reference to components of the lower vehicle with the letter A, and reference to components of the upper vehicle with the letter B.

Stacking Method

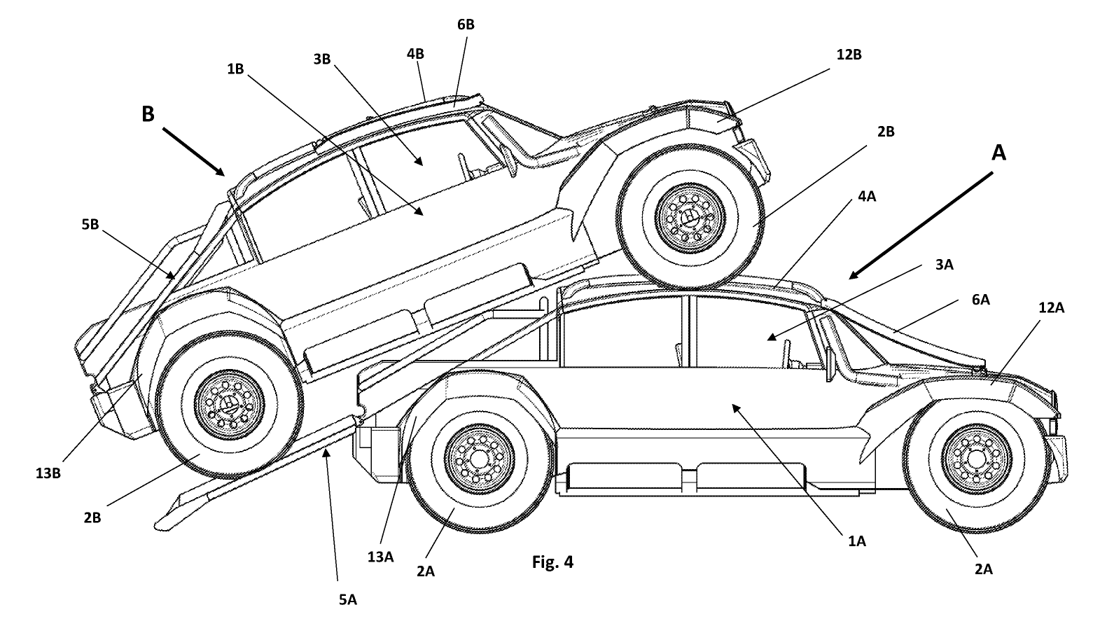

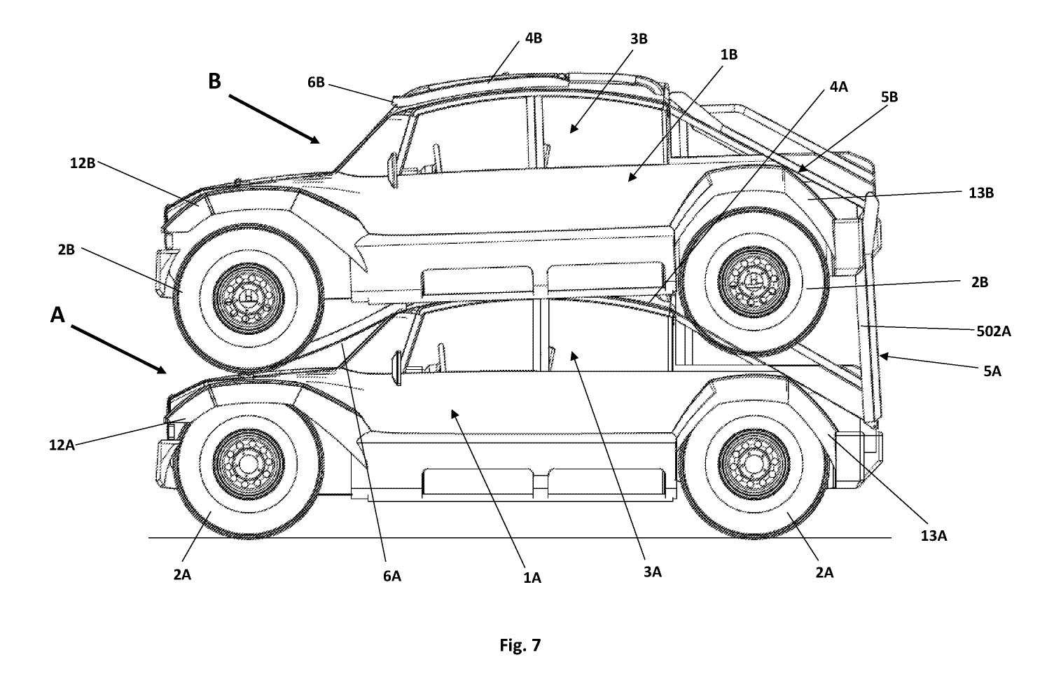

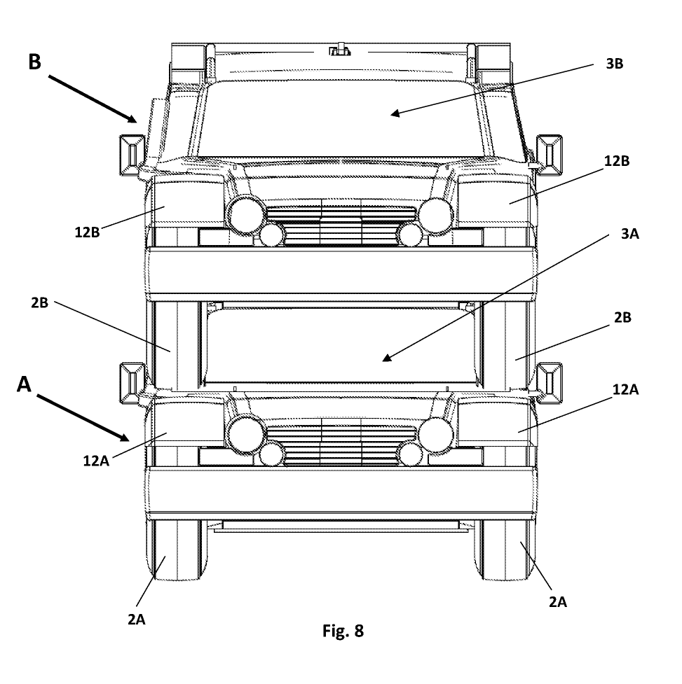

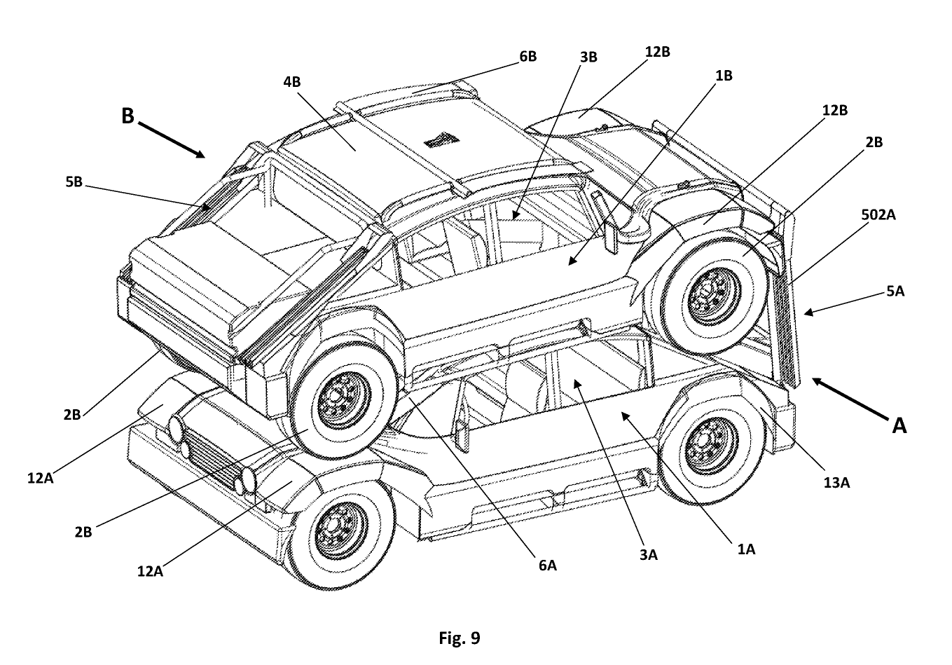

A preferred embodiment of the method of present invention is shown in FIGS. 4 to 10. As previously stated, the method of the present invention is a method for stacking two motor vehicles, said two vehicles being a first vehicle (A), also referred to as lower vehicle (A), and a second vehicle (B), also referred to as upper vehicle (B). Preferably, the first vehicle (A) and the second vehicle (B) are generally identical or similar, and both vehicles generally comprise a vehicle body (1A, 1B), front and rear wheels (2A, 2B), front (12A, 12B) and rear (13A, 13B) fenders, a cabin (3A, 3B), and a cabin roof (4A, 4B).

While the stacking method of the present invention will be described herein as a method for stacking, vehicles in which both vehicles have same orientation, the method is also valid for stacking vehicles which do not have the same orientation. Consequently, and for the effects of the present specification, the terms “front wheel” or “forward wheel” in regards to the upper vehicle (B) may indistinctly refer to the wheels in the front axle or the rear axle of the upper vehicle (B), and refer specifically to the frontmost wheels of the upper vehicle (B) in regards to the movement direction of the same. Likewise, the terms “rear wheel” or “back wheel” refer specifically to the rearmost wheels of the upper vehicle (B) in regards to the movement direction of the same.

In the preferred embodiment of the present invention, the stacking method comprises the steps of
1—Providing a set of rear ramps (5A) at the rear part of the lower vehicle (A), said rear ramps (5A) linking the rear part of the roof (4A) of the cabin (3A) of the lower vehicle (A), to the ground.
2—Providing a set of front ramps or supports (6A) in the front part of the roof (4A) of the cabin (3A) of the lower vehicle (A). Said set of front ramps or supports (6A) being such that the front wheels (2B) of the upper vehicle (B), can roll over the same.
3—Rolling the upper vehicle (B) on said rear ramps (5A) of the lower vehicle (A) so that the upper vehicle (B) ascends or climbs from a position on the ground to a position on top of the roof (4A) of the lower vehicle (A).
4—Continuing rolling said upper vehicle (B) on the roof (4A) and on the front ramps or supports (6A) of the lower vehicle (A) until it reaches a final stack position. Said final stack position may be indicated by a stopping means.
5—Securing the upper vehicle (B) to the lower vehicle (A) by a suitable fastening means. Preferably, the fastening force of the fastening means is such that the suspensions (not shown) of the upper vehicle (B) are compressed by about 3 to 5 cm, thus reducing the overall height of the vehicle stack.
6—Finally, removing, folding or retracting part of or the entirety of the rear ramps (5A) of the lower vehicle (A).

The terms “roll”, “rolling” and the like in reference to the upper vehicle (B) should be understood as the act of driving, pushing, pulling or otherwise moving the upper vehicle (B) to make it advance across the rear ramps (5A), the roof (4A) and/or the front ramps or supports (6A) of the lower vehicle (A).

The final stacking position is preferably a position in which the upper vehicle (B) and lower vehicle (A) are substantially vertically aligned. In this final stacking position, the front wheels (2B) of the upper vehicle (B) rest upon the front ramps or supports (6A) of the lower vehicle (A) and the rear wheels (2B) of the upper vehicle (B) rest upon either a part of the rear ramps (5A) of the lower vehicle (A) or a part of the roof (4A) of the lower vehicle (A). This way, the weight of the upper vehicle (B) in the final stacking position is being supported almost in its entirety by the structure of the cabin (3A) of the lower vehicle (A). Furthermore, this final position provides an efficient interlocking of the silhouettes of both vehicles (A)(B), since the front and rear wheels (2B) of the upper vehicle (B) rest at a height that is lower than the height of the roof (4A) of the lower vehicle (A). This reduces the overall height of the vehicle stack in relation to stacking methods known in the art in which the wheels of the upper vehicle (B) rest directly on top of a roof of the lower vehicle (A).

This interlocking of the silhouettes of the vehicles takes advantage of the fact that in most motor vehicle designs, the cabin of the vehicle is located between the front and rear wheels, and as a result, a pair of vehicles stacked on top of one another would not show major interference between the geometry of the cabin of the lower vehicle (A) and the space occupied by the wheels of the upper vehicle (B).

Preferably, the upper vehicle (B) has a floor (11B) which comprises a concavity such that it allows for a slight interlocking of the same with the roof (4A) of the lower vehicle (A). This allows for a greater reduction of the total height of the vehicle stack.

The fastening means for securing the upper vehicle (B) to the lower vehicle (A) may be for example a set of slings. In a preferred embodiment of the present invention, the stopping means and the fastening means may be a stopping and fastening means that carries out both functions. In another preferred embodiment of the present invention, the stopping means and the fastening means may be a set of devices or components, some placed on the lower vehicle (A) and some placed on the upper vehicle (B), which operate in conjunction to fasten the vehicles together.

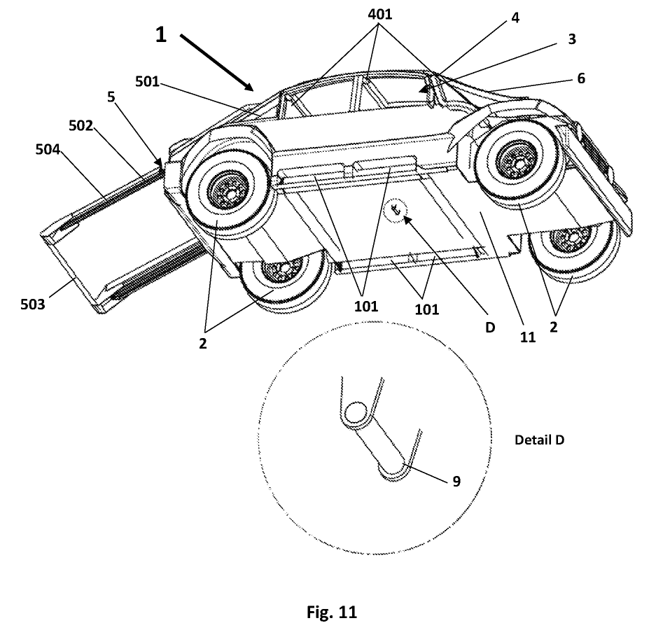

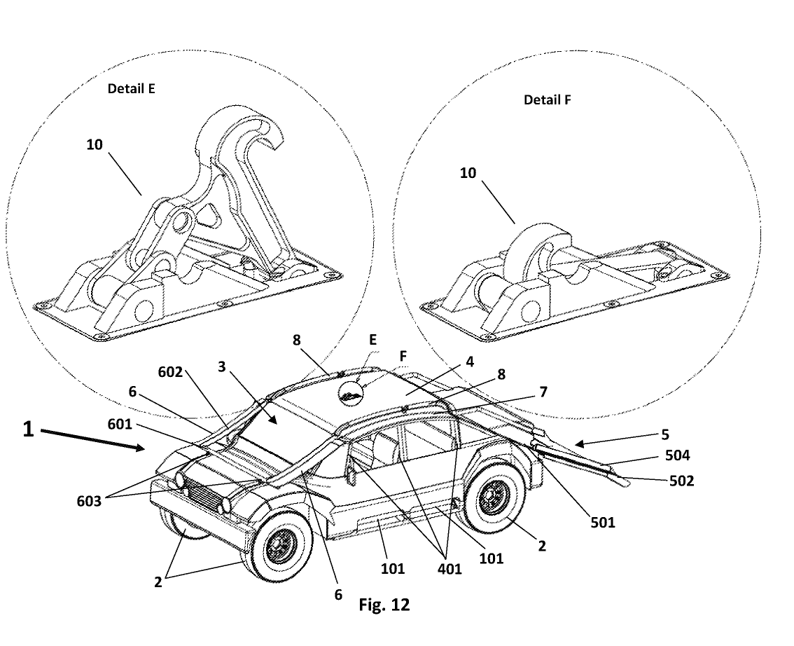

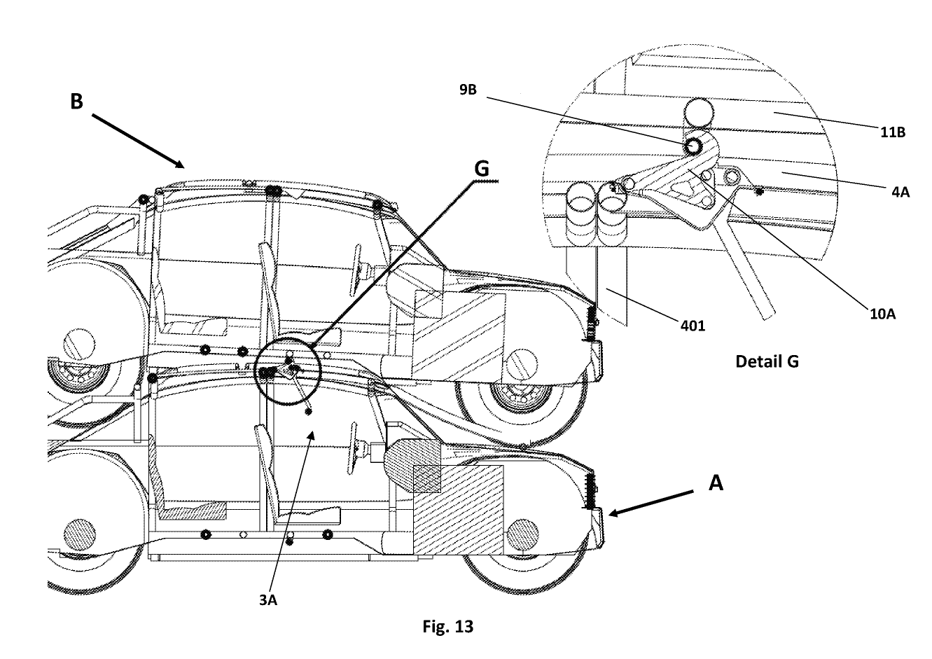

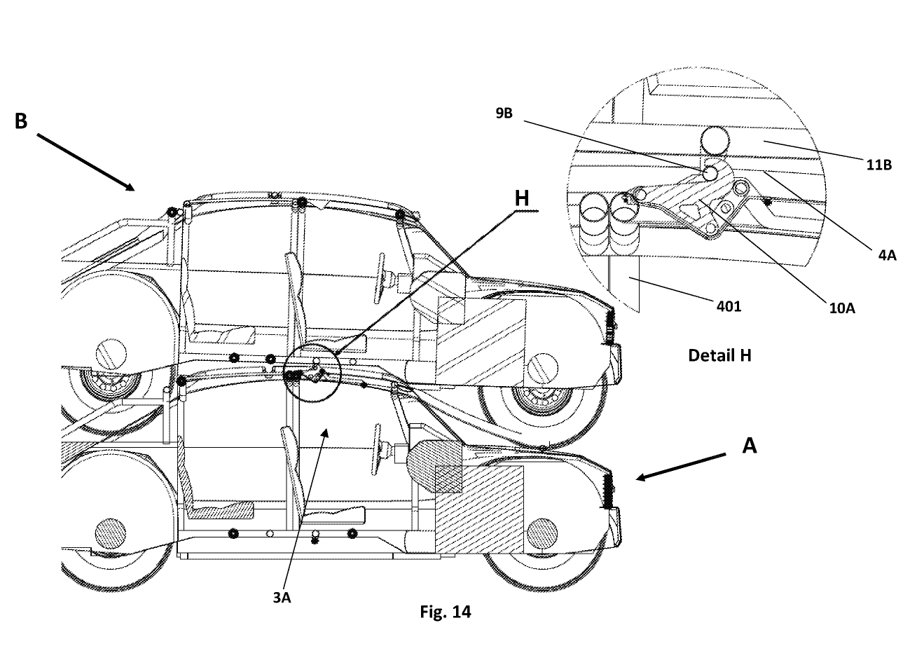

By way of an example, a preferred embodiment of the present invention is shown in FIGS. 11 and 12, showing a stackable vehicle in which the stopping and fastening means comprise rod (9) located on the lower part of the floor (11) of the vehicle and an articulated hook (10) located on top of the roof (4) of the vehicle which can engage with a rod (9) of another vehicle when stacked, such as is shown in FIGS. 13 and 14. Said Figures show a stack of two vehicles in accordance with the method of the present invention, in which the hook (10A) of the stopping and fastening means of the lower vehicle (A) engages the rod (9B) of the stopping and fastening means of the upper vehicle (B), fastening or securing both vehicles together.

For the purpose of carrying out the stacking method of the present invention only the rod (9B) of the stopping and fastening means of the upper vehicle (B) and the hook (10A) of the stopping and fastening means of the lower vehicle (A) are required. However, in a preferred embodiment of the present invention, both the lower vehicle (A) and the upper vehicle (B) comprise both elements, the rod (9) and the hook (10), thus allowing both vehicles to act either as lower vehicle or upper vehicle, allowing the stacking order of the vehicles to be reversed.

In another embodiment of the present invention, the stopping and fastening means comprises a bolt and a screw.

Another advantage of the method of the present invention is that, when rolling the upper vehicle (B) over the roof (4A) of the lower vehicle (A), there is no interference between protruding elements or components of the vehicles, such as rear-view mirrors, exhaust pipes, air intakes, etc. (not shown). Additionally, this design allows for temporal storage of transportable equipment (not shown) such as backpacks, tools, equipment, etc. at the sides of the vehicle without obstructing the stacking operation.

Since in the stacking method of the present invention neither the elements required for the stacking operation, nor the upper vehicle (B) interfere with the normal operation of the lower vehicle (A), the method of the present invention allows for an occupant of the lower vehicle (A) to drive said vehicle while in a stack of two vehicles (A, B). This means that, after the stacking operation, the lower vehicle (A) and consequently the stack of two vehicles (A, B) can be driven by an occupant to its destination, this being a cargo compartment of a transport vehicle, a cargo container, a storage warehouse, a parking lot, etc. Once the vehicle stack is in a desired position inside a transport vehicle or container, the stack is secured to the transport means by typical cargo securing means.

The transporting of vehicles stacked with the method of the present invention allows for transporting twice the number of vehicles per unit surface than typical transport methods, and the greater density in weight of transported equipment per unit volume or surface of cargo allows for a better use of the maximum load capacity of the transport used.

Furthermore, the storage of vehicles stacked with method of the present invention allow for storing twice the number of vehicles per unit surface, since it allows for storing two vehicles in the space or surface typically destined to store a single vehicle. This efficiency in the storage of equipment and supplies is particularly critical in high risk operations or in protected, areas, such as in military forces or security operations.

Finally, in order to unload or unstuck a pair of vehicles stacked according to the method of the present invention, all the steps involved with the stacking method of the present invention must be carried out in reverse order.

Stackable Vehicle

With the object of carrying out the stacking method of the present invention previously described, the invention further provides an all-terrain stackable motor vehicle which can be stacked on top of another identical or similar vehicle, and which can withstand the weight of an identical or similar vehicle stacked over it. Furthermore, the all-terrain stackable motor vehicle of the present invention is such that it can perform stacking and unstacking operations without the need for external tools or equipment. For a better understanding of the following description, all references to the terms “vehicle”, “stackable vehicle”, “upper vehicle”, “lower vehicle” and the like will now be made in reference to the stackable vehicle described herein and not to a generic vehicle. Furthermore, all references to “stacking method” o “stacking operation” and the like will now be made in reference to preferred embodiments of the stacking method of the present invention as previously described.

As previously described and illustrated, the method for stacking vehicles of the present invention comprises a step in which an upper vehicle (B) rolls over the roof (4A) of the cabin (3A) of a lower vehicle (A), until it reaches a final stacking position in which part of the weight of the upper vehicle (B) is supported by the structure of the cabin (3A) of the lower vehicle (A). One of the advantageous features of said method is taking advantage of the inherent resistance of the cabin of the vehicle without requiring additional reinforcements which would needlessly increase the weight of the vehicle.

This is because, according to the IIHS HLDI standards (Insurance Institute for Highway Safety Highway loss data institute), a pick-up vehicle must have a roof capable of withstanding between 3 to 4.5 times the weight of the vehicle, with a deformation no greater than 5 inches. According to FIA standards (Federation Internationale de l'Automobile), for sports vehicles or all-terrain vehicles, this requirement may rise to up to 7.5 times the weight of the vehicle with a deformation no greater than 100 mm. Taking this design requirements into account, the cabin of a vehicle according to the IIHS HLDI standards should be able to withstand the weight of an identical vehicle stacked on top of it. Consequently, since in the vehicle of the present invention most of the weight of the upper vehicle (B) is supported by the roof of the lower vehicle (A), in preferred embodiments of the present invention the design of the stackable vehicle conforming to IIHS HLDI standards does not require the addition of reinforcements to the roof or to the pillars of the same, which would otherwise increase the weight of the vehicle compared to a vehicle with a roof of standard construction. This presents an advantage over designs know in the art such as the previously mentioned VLEGA Gaucho, which requires reinforced fenders that have increased weight but provide no additional protection to the occupants.

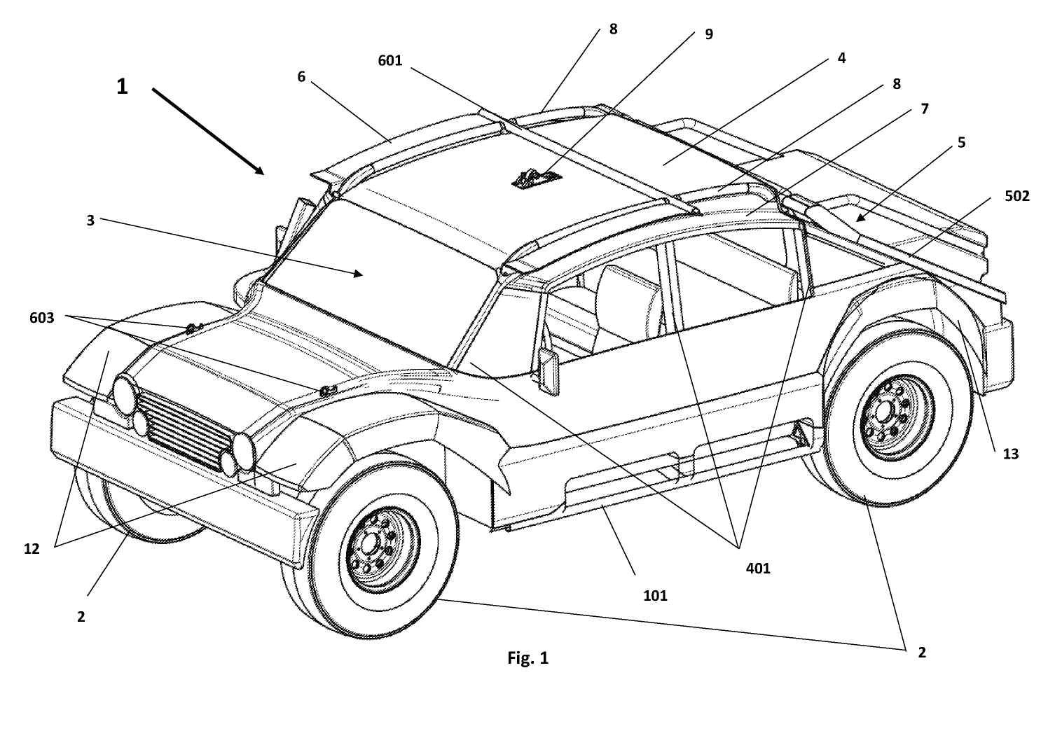

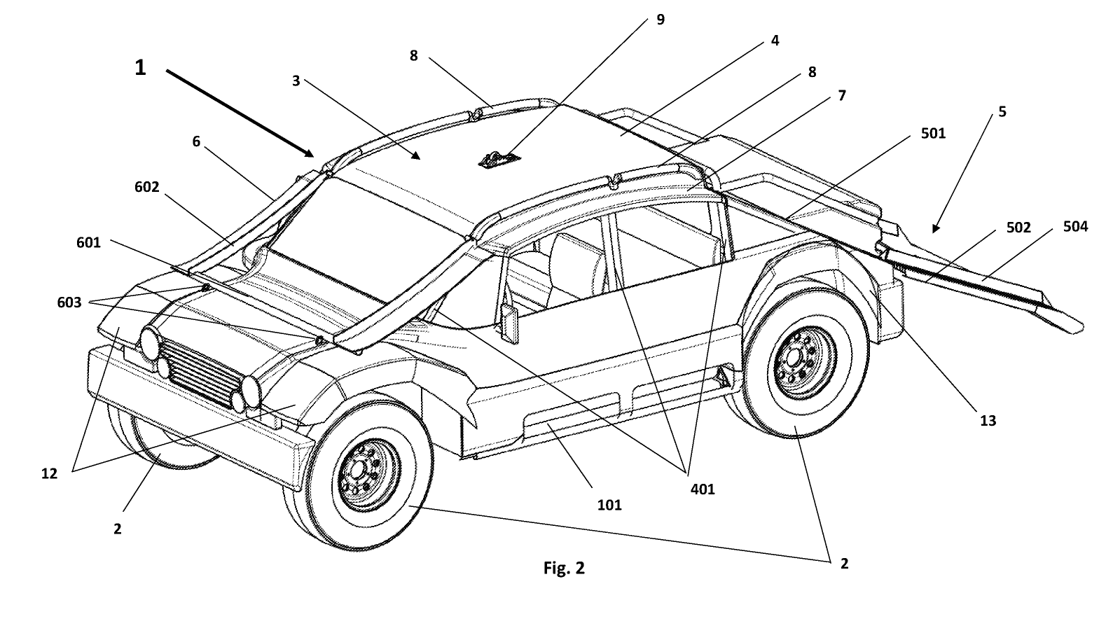

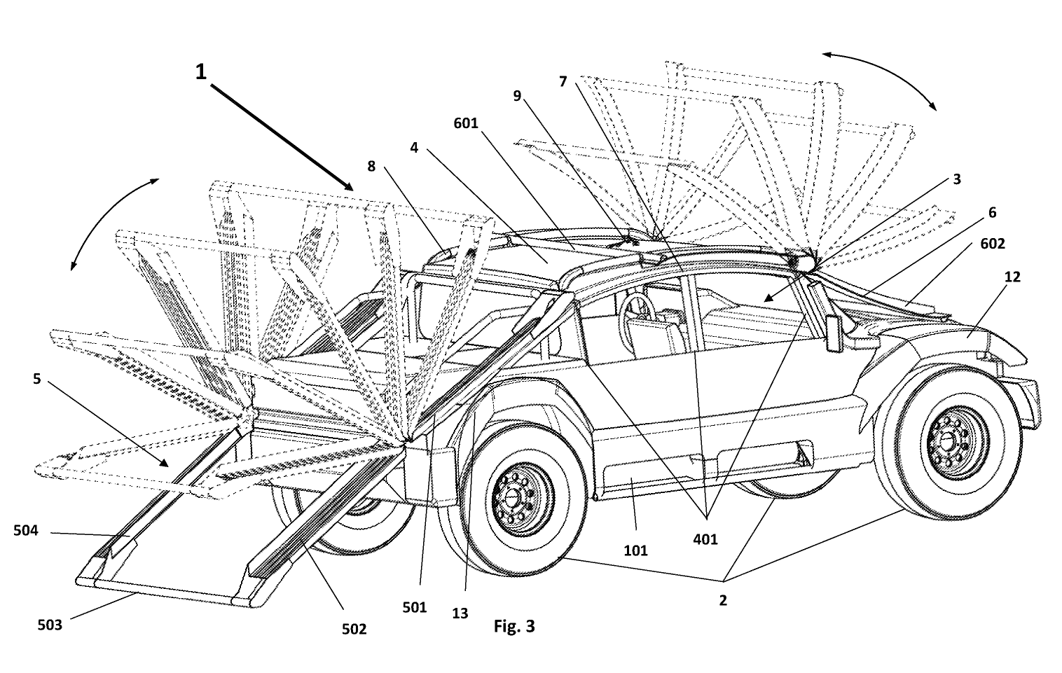

In this regard, a preferred embodiment of the stackable vehicle of the present invention is shown in FIGS. 1 to 3 and 11 to 12. Said stackable vehicle comprises: a motor vehicle body (1) comprising an inner structure (not shown), four wheels (2), front (12) and rear (13) fenders, a cabin (3) comprising a roof (4), a pair of foldable/retractable/detachable rear ramps (5), a pair of foldable/retractable/detachable front ramps or supports (6), a pair of rear supports or anchors (not shown) for coupling said rear ramps (5) to the rear part of the roof (4) of the cabin (3), and a pair of frontal supports or anchors (not shown) for coupling said front ramps (6) to the front part of the roof (4) of the cabin (3). The roof (4) of the cabin (3) of the vehicle is convex and curved. The vehicle of the present invention further comprises a lower stopping and fastening means (9) in the lower part of the floor (11) of the vehicle as shown in FIG. 11, detail D and an upper stopping and fastening means (10) on the roof (4) of the vehicle as shown in FIG. 12, details E and F.

In a preferred embodiment of the present invention as shown in FIGS. 1 to 3, the roof (4) of the cabin (3) of the vehicle is a curved surface which is supported by a plurality of pillars (401). The roof (4) comprises an inner structure which comprises a set of arcs and beams (not shown) that provide the roof (4) with resistance to deformation and the resistance to withstand the weight of a vehicle stacked on top of it, in accordance with the requirements previously mentioned. The external surface of the roof (4) of the cabin (3) presents a convex curvature and provides a surface on which the wheels (2) of an upper vehicle can roll on during the stacking operation. The curvature of the roof (4) and the height of the floor (11) of the vehicle are such that when an upper vehicle is rolling on the roof of a lower vehicle, there is no friction between them.

The curved and convex design of the roof (4) allows for a smooth transition between the rear ramps (5) and the front ramps (6) for an upper vehicle during the ascent/descent in the stacking/unstacking operation, and also allows for a greater interlocking of the silhouettes of the vehicles in final stacking position, which helps reduce the total height of the stack.

In another embodiment of the present invention, the roof (4) may be faceted, with descending angles on the front and rear ends, thus obtaining similar benefits to those of a curved roof (not shown).

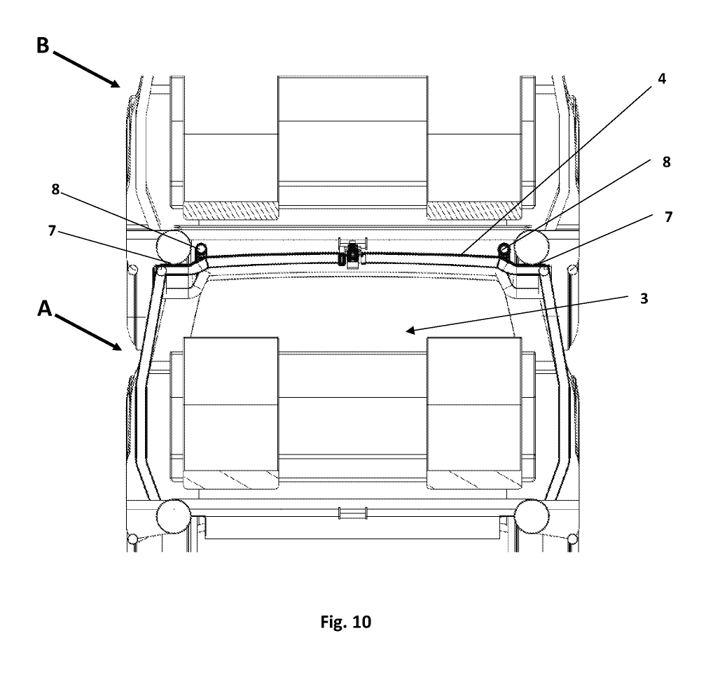

In a most preferred embodiment of the present invention, the roof (4) of the cabin (3) further comprises two depressed or stepped regions or strips (7) located one on each side of the same and which run the entire length of the roof (4), aligned with the front (6) and rear (5) ramps. This is to say, said regions or strips (7) are located where the wheels (2) of an upper vehicle will roll on during the stacking operation, as shown in FIG. 10, and are thus referred to as rolling strips (7). In said rolling strips (7), the height of the roof (4) is relatively lower than that of the rest of the roof (4). These rolling strips (7) are intended to reduce the height to where an upper vehicle must be raised during the stacking operation, thus reducing the length of the rear ramps (5) and reducing the total height of the vehicle stack, and forms by way of its step or depression a guide for keeping the wheels (2) of the upper vehicle correctly aligned during the stacking process.

In embodiments of the present invention in which the roof (4) comprises said rolling strips (7), the roof (4) may also comprise additional supports, which comprise a frame, or structure to reinforce the outer edge, of said rolling strips (7) (not shown).

Additionally, in a preferred embodiment of the present invention, the roof (4) of the vehicle comprises a pair of tubular structures (8), one on each side of the vehicle roof (4), running the entirety or a large portion of the length of the same, framing the rolling strips (7) and aligned with the front (6) and rear (5) ramps. Said tubular structures (8) are intended to provide greater rigidity to the roof (4) of the cabin (3), function as an additional guide for orienting the wheels (2) of an upper vehicle during the stacking operation, function as a luggage carrier or as a support for strapping equipment, and as a hold for personnel being transported outside the cabin (3), which may use stirrups (101) located on the vehicle for support.

In a preferred embodiment of the present invention, said tubular structures (8), are fixed to the internal structure (not shown) of the roof (4) of the cabin (3), thus providing it with greater rigidness.

While in preferred embodiments of the present invention the roof (4) of the cabin (3) is curved or faceted, another possible embodiment for said roof (4) is a substantially flat roof (not shown). Considering that in this embodiment the straight stretch which an upper vehicle must ascend to reach the roof (4) of the lower vehicle (A) is greater than in the other embodiments with curved or faceted roofs previously described, in order to have the same ascent angle than in said embodiments, the rear ramps (5) must be longer.

Regardless of the chosen configuration of the roof (4), the cabin (3) of the vehicle of the present invention preferably has the capacity to carry at least two occupants.

Rear Ramps

As previously described, in preferred embodiments of the present, the vehicle of the invention comprises a pair of foldable/retractable/detachable rear ramps (5) at both sides of the rear end of the roof (4) of the cabin (3). Said rear ramps (5) allow for an upper vehicle of the present invention to be driven or rolled from a rest position on the ground to a final rest position on top of a lower vehicle, during a stacking operation according to the stacking method of the present invention. During normal operation of the vehicle, the rear ramps (5) of the vehicle are in a folded/retracted/detached position. During a stacking operation according to the stacking method of the present invention, the rear ramps (5) of the lower vehicle are in deployed/extended position until the end of the stacking operation.

In a preferred embodiment of the present invention, the rear ramps (5) comprise a fixed pact (501) and a moving part (502). The fixed part (501) of each of said rear ramps (5) is substantially straight and links the rear end of the roof (4) with the rear end of the vehicle, preferably to a rear bumper. Preferably, the splicing or joint between the fixed part (501) of the rear ramps (5) and the roof (4) is tangent or substantially tangent to the curvature of the same, thus allowing for a smooth transition from the rear ramps (5) to the roof (4) for an upper vehicle during the stacking operation.

The moving part (502) of each of said rear ramps (5) is substantially straight and is movingly linked by one of its ends to the rear end of the corresponding fixed part (501) by means of a rotation, folding or retracting means, such as a hinge or similar. Said rear end of the fixed part (501) is the end located on the rear end or rear bumper of the vehicle. This link between the fixed part (501) and the moving part (502) provides the rear ramps (5) with the capacity to fold, rotate or retract upon itself and allows it to assume a plurality of configurations or positions. In a preferred embodiment of the present invention, a transversal bar or beam (503) links the other end of the moving parts (502) of the rear ramps (5) together, keeping them aligned and moving together. In another preferred embodiment of the present invention, an inner edge of the rear ramps (5) comprises a vertical protrusion, projection or profile (504) which serves as a guide for the wheels (2) of an upper vehicle during the stacking operation.

In a first position of the rear ramps (5), referred to as ‘folded position’, the moving parts (502) of the rear ramps (5) lay or are folded on the corresponding fixed parts (501). This folded position is the position used for the rear ramps (5) daring normal operation of the vehicle, when it is not in a stacking operation. In a preferred embodiment of the present invention, the roof (4) of the vehicle comprises a pair of tubular structures (8) as previously described, and said tubular structures (8) each comprise a depression or grove located where the transversal bar or beam (503) of the rear ramps (5) would rest on the roof (4) when the rear ramps (5) are in folded position.

In a second position of the rear ramps (5), referred to as ‘deployed position’, the moving parts (502) of the rear ramps (5) are moved or rotated in such a way that one of their ends is in contact with the ground and the other end is in contact with the corresponding fixed part (501) of the rear ramps (5). In this deployed position, the moving parts (502) and the fixed parts (501) of the rear ramps (5) form a pair of continuous and substantially straight ramps that link the rear end of the roof (4) of the vehicle to the ground.

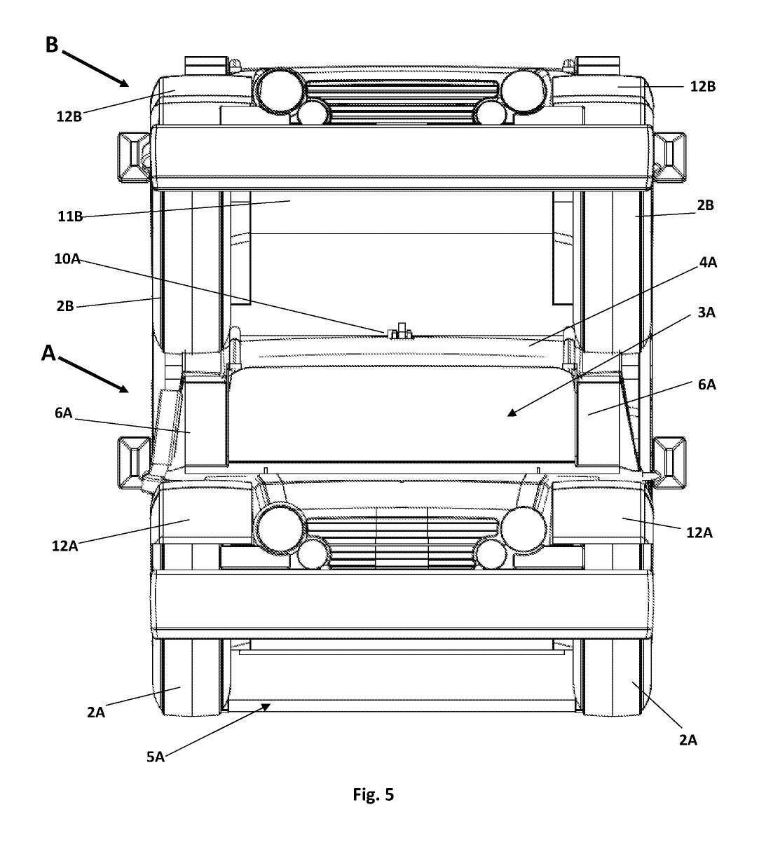

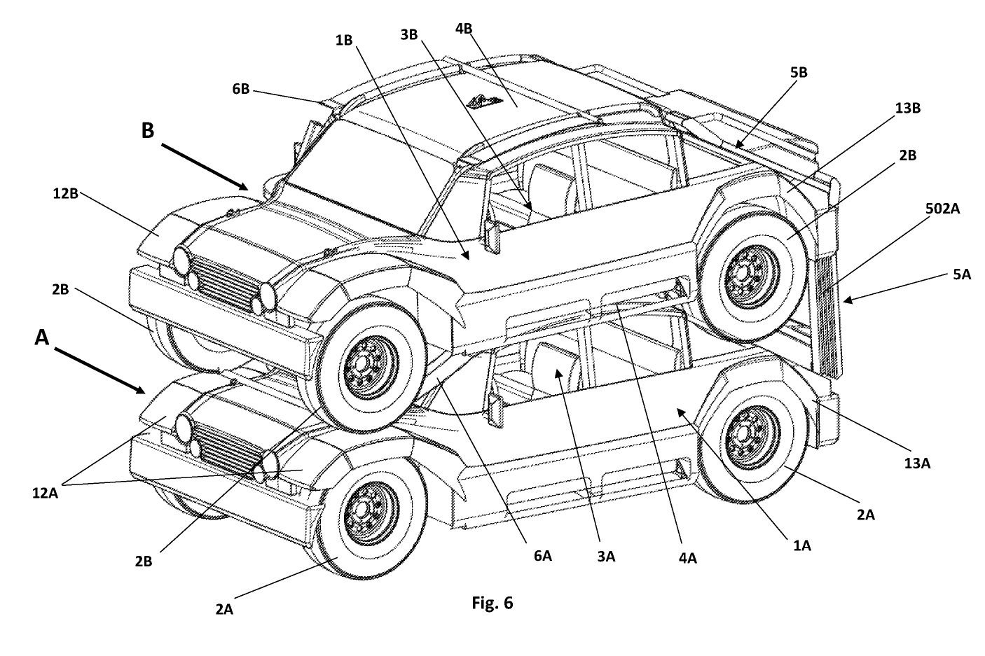

At the start of a stacking operation of an upper vehicle (B) of the present invention on top of a lower vehicle (A) of the present invention, as shown in FIGS. 4 and 5, the rear ramps (5B) of The upper vehicle (B) are on the folded position, while the rear ramps (5A) of the lower vehicle (A) are on the deployed position. The upper vehicle (B) is rolled or driven on said rear ramps (5A) of the lower vehicle (A) and then over the roof (4A) of the lower vehicle (A) until reaching a final resting position on top of the lower vehicle (A), as shown in FIGS. 6 to 10. Once the upper vehicle (B) is on the final resting position, as shown in FIGS. 6 to 10, the rear ramps (5A) of the lower vehicle (A) are placed in a third position in which the moving part (502A) of the rear ramps (5A) of the lower vehicle (A) are oriented in a substantially vertically upwards direction, preferably in contact with a rear bumper of the upper vehicle (B). In this third position, the moving part (502A) of the, rear ramps (5A) of the tower vehicle (A) is secured in place by any suitable securing means (not shown).

In a preferred embodiment of the present invention each of the rear ramps (5) is provided with a spring (not shown) connecting the moving parts (502) of the rear ramps (5) to the structure of the vehicle (1) to a point (not shown) that is lower in height to the rear end of the fixed parts (501) of the rear ramps (5), where the moving parts (502) of the rear ramps (5) are connected to the fixed parts (501). The force applied by these springs (not shown) on the moving parts (502) will prevent said moving parts (502) from remaining in any position other than the first, second or third position mentioned above. Furthermore, said force applied by said springs will assist in holding the moving parts (502) of the rear ramps (5) in proper position during normal operation and stacking operations.

In another embodiment of the present invention, the moving part (502) of the rear ramps (5) may be telescopic, articulated, or any other mechanical system that allows for certain degrees of movement.

In yet another embodiment of the present invention, the rear ramps (5) are totally or partially removable. In this embodiment, the moving parts (502) of the rear ramps (5) are coupled to said previously mentioned rear supports or anchors (not shown) in the deployed position during the stacking operation. Then, during relocation or transport of the two stacked vehicles, the moving parts (502) of the rear ramps (5) of the lower vehicle (A) may be removed and transported together with the vehicles, on the vehicles or otherwise. Furthermore, said moving parts (502) of the rear tamps (5) may be removed during normal operation of the vehicle.

Front Ramps

As previously described, the cabin (3) of the vehicle further comprises a pair of foldable/retractable/detachable front ramps or supports (6). Said front ramps (6) are located on both sides of the, front end of the roof (4) of the cabin (3) and can adopt either a folded position or a deployed position. During normal operation of the vehicle, or when the vehicle is the upper vehicle of a vehicle stacking operation, the front ramps (6) are in a folded position. During a stacking operation, the front ramps (6) of the lower vehicle (A) are in a deployed position. The front ramps (6), while in deployed position, form a pair of extensions of the lateral portions of the roof (4) of the vehicle over which the wheels (2) of an upper vehicle roll on during the stacking operation, as well as supporting the front wheels (2) of the upper vehicle when the vehicles are in final stacking position, as shown in FIGS. 6 to 10. In a preferred embodiment of the present invention, a transversal bar or beam (601) links the ends of each of the front ramps (6) together, keeping them aligned and moving together. When the front ramps (6) are in deployed position, said transversal bar or beam (600 rests on the hood of the vehicle at its most resistant point of the inner structure of the vehicle body (1), which may be, for example, the point (603) where the suspension elements of the front wheels of the vehicle are anchored (not shown).

In another preferred embodiment of the present invention, an inner edge of the front ramps (6) comprises a vertical protrusion, projection or profile (602) which serves as a guide for the wheels (2) of the upper vehicle (B) during the stacking operation.

In another embodiment of the present invention, the front ramps (6) may be telescopic, articulated, or have any other mechanical system that allows far certain degrees of movement instead of foldable.

In yet another embodiment of the present invention, the front ramps (6) are totally or partially removable. In this embodiment, the front ramps (6) are coupled to said previously mentioned rear supports or anchors (not shown) in deployed position during the stacking operation, and totally or partially removed during normal operation of the vehicle.

At the start of a stacking operation of an upper vehicle (B) of the present invention on top of a lower vehicle (A) of the present invention, as shown in FIGS. 4 to 5, the lower vehicle (A) has its rear ramps (5A) and front ramps (6A) in deployed position, and the upper vehicle (B) has its rear ramps (5B) and front ramps (6B) in folded position. The upper vehicle (B) is driven or rolled so that it climbs on top of the lower vehicle (A) by means of the deployed rear ramps (5A) of the same. Upon reaching the roof (4A) of the lower vehicle (A), the upper vehicle (B) continues to roll on the surface of the roof (4A) of the lower vehicle (A) until the front wheels (2B) (or the rear wheels if the vehicles are stacked with inverted orientation) of the upper vehicle (B) reach the deployed front ramps (6A) of the lower vehicle (A). The upper vehicle (B) reaches a final stacking position as shown in FIGS. 6 to 10, in which the front or rear wheels (2B) of the same, depending on its orientation, rest upon the deployed front ramps (6A) of the lower vehicle (A), and the rear wheels or front (2B) of the same, depending on its orientation, rest upon the rear ramps (5A) of the lower vehicle (A). In this final position, the rear ramps (5A) of the lower vehicle (A) are in the third position.

Stopping and Fastening Means

Preferably, the stackable vehicle of the present invention further comprises stopping and fastening means for indicating the final stacking position of an upper vehicle over a lower vehicle during the stacking operation, and also for securing both vehicles together once the upper vehicle reaches said final stacking position. In a preferred embodiment of the present invention, the vehicle comprises a lower stopping and fastening means (9) located on the external side of the floor (11) of the vehicle, and an upper stopping and fastening means (10) located on the external side of the roof (4) of the cabin (3) of the vehicle.

In a preferred embodiment of the present invention as shown in FIGS. 11 and 12, the lower stopping and fastening means (9) comprise a transversal rod, and the upper stopping and fastening means (10) comprise a movable coupling mechanism. Said movable coupling mechanism may be telescopic, articulated or any other suitable type which allows the same to adopt at least two positions, a stopping position and a fastening position.

During the initial steps of a stacking operation of an upper vehicle (B) on top of a lower vehicle (A) as shown in FIGS. 4 and 5, the upper stopping and fastening means (10A) of the lower vehicle (A) are initially in stopping position. As previously described, the upper vehicle (B) is driven or rolled so that it climbs on the deployed rear ramps (5A) of the lower vehicle (A) and then driven or rolled over the roof (4A) of the same, until the lower stopping and fastening means (9B) of the upper vehicle (B) make contact with the upper stopping and fastening means (10A) of the lower vehicle (A), as shown in FIG. 13. This indicates that the upper vehicle (13) is in final stacking position and stops the movement of the upper vehicle (B). At this point, the upper stopping and fastening means (10A) are actuated so that the same goes from the stopping position to the fastening position, in which the upper stopping and fastening means (10A) of the lower vehicle (A) firmly capture and secure the lower stopping and fastening means (9B) of the upper vehicle (B), fastening together both vehicles.

In a preferred embodiment of the present invention, when going from the stopping position to the fastening position, the force of the coupling mechanism of the upper stopping and fastening means (10) is such that it compresses the suspension of the upper vehicle (B), effectively lowering the overall height of the vehicle stack. Preferably, the compression of the suspension of the upper vehicle (B) and consequent reduction of the total height of the stack is approximately 3 to 5 cm.

Actuation of the coupling mechanism of the upper stopping and fastening means (10) may be carried out by automatic or manual means. In the case of manual actuating means, these may be located within the cabin (3) and actuated by an occupant inside the vehicle, or may be located externally and actuated from outside the cabin (3). For manual actuating means, the actuating means will depend on the type of mechanism used for the upper stopping and fastening means (10). By way of a non-limiting example, in an embodiment of the present invention the upper stopping and fastening means (10) is a bolt and nut system, and the manual actuating means is a swivel.

In a preferred embodiment of the present invention, as shown in FIGS. 13 and 14, the mechanism of the upper stopping and fastening means (10) is of the articulated hook type, and the manual actuating means is a lever. In this embodiment, in a stacking operation the manual actuation is performed by an occupant inside the cabin (3A) of the lower vehicle (A) who must provide the force necessary to change the upper stopping and fastening means (10A) from the stopping position to the fixing position, as well as the force necessary to compress the suspensions of the upper vehicle (B). In this preferred embodiment, while in stopping position, the height of the articulated hook of the upper stopping and fastening means (10) is such that even if the upper vehicle (B) has alignment defects, shifts in the suspension or height variations of any kind, the stopping and fastening means is still capable of correctly stopping and fastening the lower stopping and fastening means (9) of the upper vehicle (B). However, said height is such that it does not interfere nor hinder the ascent of the upper vehicle (B) in any way during the stacking operation.

As it can be appreciated, the stacking method of the present invention using the stackable vehicle of the present invention does not require any external tool or equipment, since all the elements needed for stacking and securing the vehicles together are components of the vehicles.

Preferably, with the object of minimizing the cargo space required by the vehicle stack, the lower stopping and fastening means (9) and the upper stopping and fastening means (10) are arranged such that in final stacking position both vehicles are vertically aligned.

It will be appreciated that during a stacking operation of two vehicles according to embodiments of the present invention, some of the stacking components on one vehicle or the other will serve no function and can be disregarded, such as, for example, the front ramps (6) and rear ramps (5) of the upper vehicle (B) or the lower stopping and fastening means (9) on the lower vehicle (A). As such it is possible to provide a fleet of vehicles according to embodiments of the present invention may have a percentage of vehicles with rear ramps (5) and front ramps (6), which can act as both lower vehicle (A) or upper vehicle (B), and a percentage of vehicles without rear ramps (5) and front ramps (6), which can only act as upper vehicles (B). Optionally, a fleet of vehicles with a determinate number of vehicles with and without ramps (5, 6) may be provided, and a determinate number of detached ramps (5, 6) may be provided, for attacking and or detaching on said vehicles as needed.

Rapid Aerial Deployment

As a further object of the present invention, rapid aerial deployment means are provided for enabling aerial deployment (airdrop) from a transport aircraft (e.g. an airplane) of all-terrain stackable motor vehicles of the present invention stacked according to the stacking method of the present invention, with minimal effort and downtime required for putting the vehicle in operative conditions after landing. The rapid aerial deployment means of the present invention allows for a pair of stackable vehicles transported in stacked configuration to be launched or dropped from a transport plane while still in a stack. The rapid aerial deployment means will then separate both vehicles in the air, deploying respective parachutes or slowing means for each vehicle, and allowing both vehicles to be in operational condition immediately upon landing.

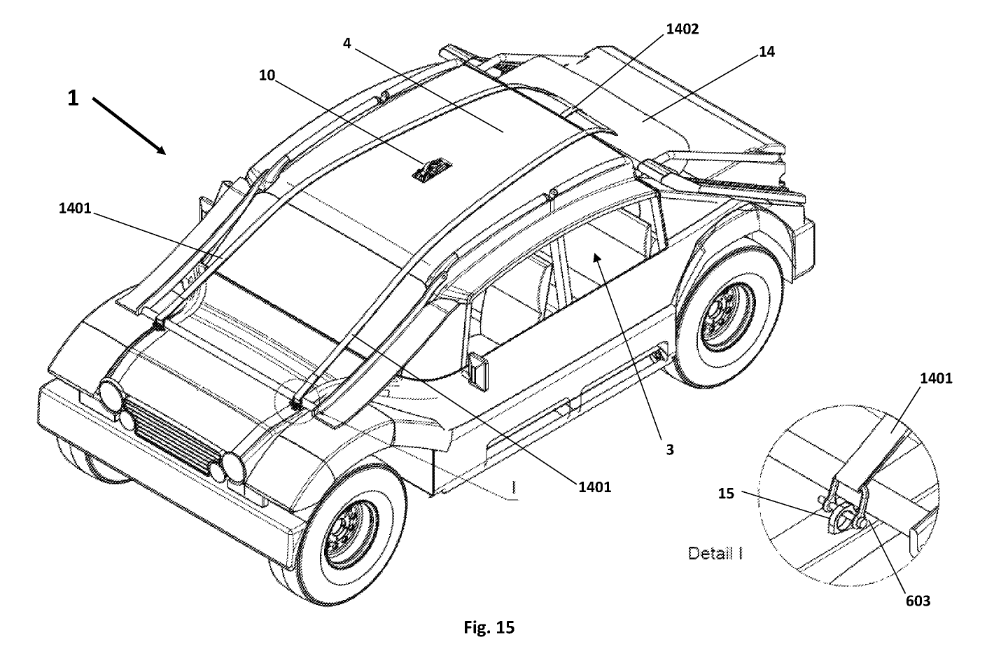

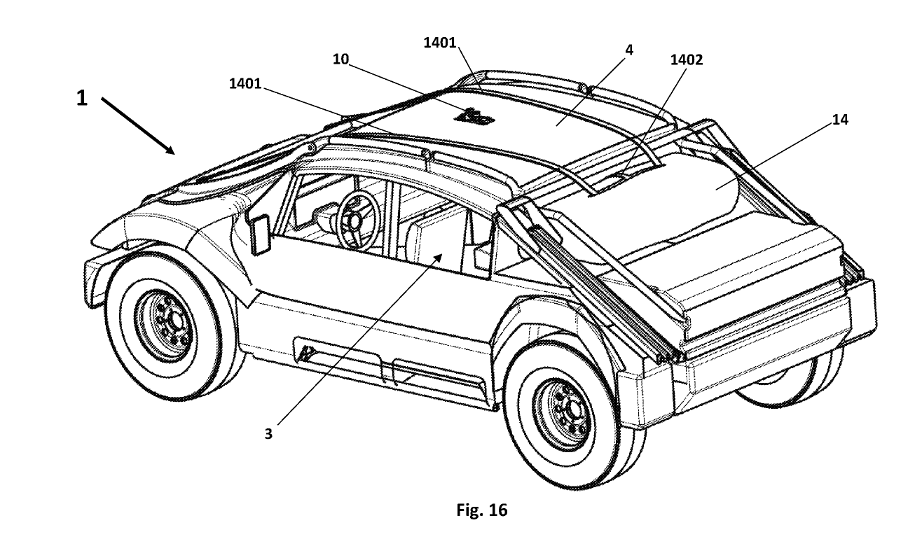

A preferred embodiment of the vehicle of the present invention having said rapid aerial deployment means of the present invention is shown in FIGS. 15 to 18 and FIGS. 19A to 19C in said preferred embodiment, the rapid aerial deployment means for a stackable vehicle of the present invention comprises

a folded parachute (14), located behind the cabin (3) of the vehicle, having a pair of front slings (1401) and at least one rear sling (1402);

a pair of front fastening points (15) located on the front of the vehicle;

a rear fastening point (16) located behind the cabin (3) of the vehicle and under the parachute (14); and

a modified lower stopping and fastening means (9).

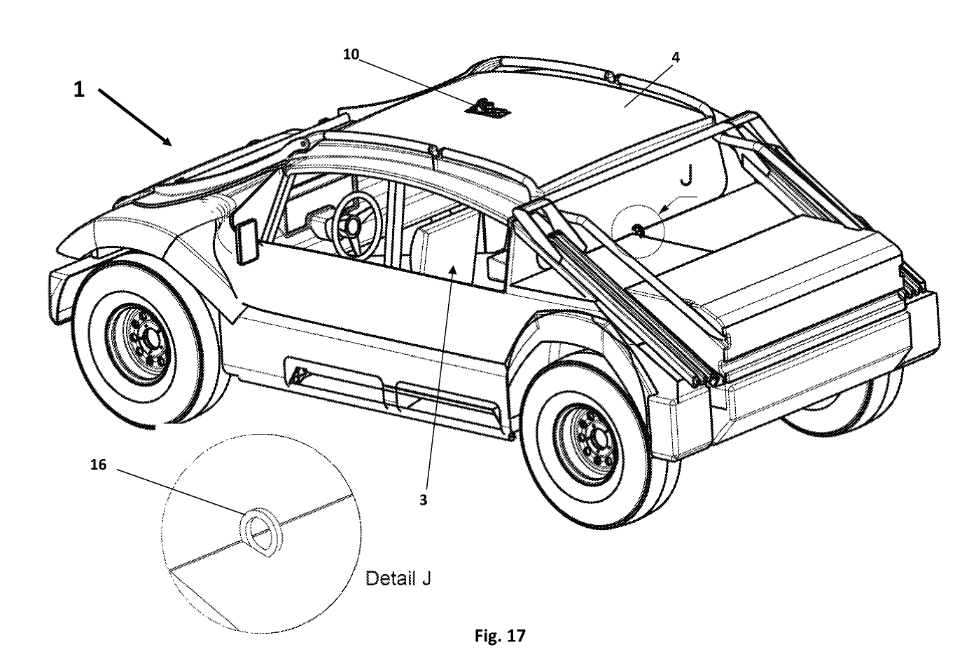

The parachute (14) may be a parachute or any other deployable slowing device for slowing down a falling vehicle to a safe landing speed, which can be unfolded or deployed in the air during the fall of the vehicle. Said parachute (14), which in its folded or stored configuration is located on the rear part of the vehicle, behind the cabin (3) of the vehicle, is fixed to the vehicle by way of its pair of front slings (1401), which are tightened over the roof (4) of the cabin (3) of the vehicle and secured to the corresponding pair front fastening points (15) on the front of the vehicle. The parachute (14) is further fixed to the vehicle by way of its at least one rear sling (1402), which is stored in folded or coiled position when the parachute (14) is folded or stored. Said at least one rear sling (1402) is secured to the rear fastening point (16) on the rear part of the vehicle, under the parachute (14). FIG. 17 shows the stackable vehicle having the rapid aerial deployment means of the present invention without the parachute, showing the rear fastening point (16), which preferably comprises a ring for hooking, tying or otherwise fastening an end of the at least one rear sling (1402) of the parachute. Additionally, said front fastening points (15) each preferably comprise a ring for hooking, tying or otherwise fastening a corresponding end of the pair of front slings (1401) of the parachute (14). In a most preferred embodiment of the present invention, the pair of front fastening points (15) are preferably located on strong points of the structure of the vehicle, such as for example the point (603) where the suspension elements of the front wheels of the vehicle are anchored.

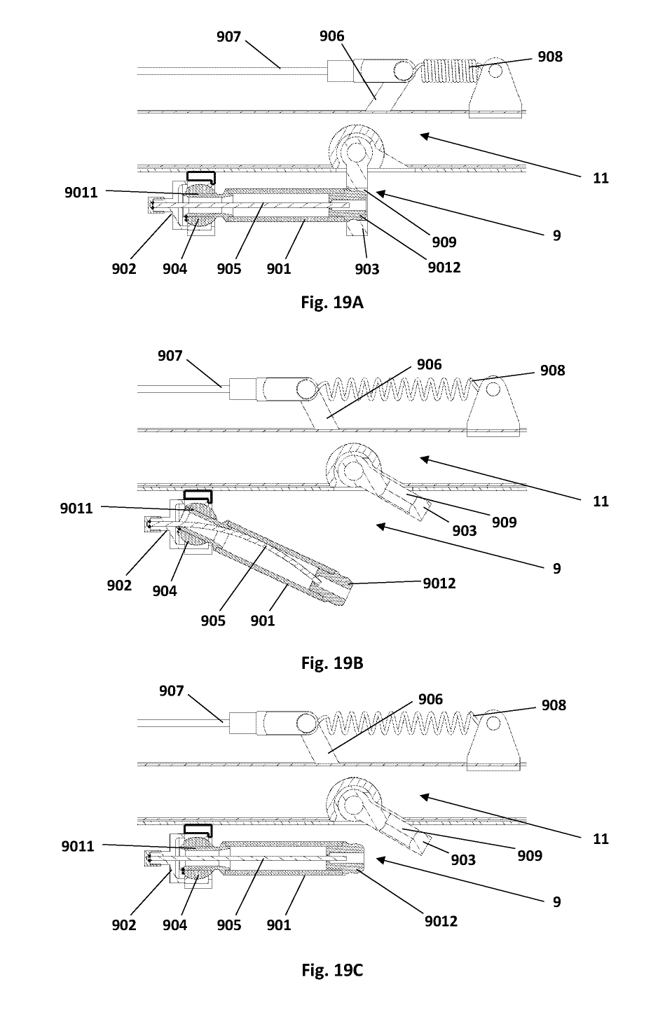

The modified lower stopping and fastening means (9) of the rapid aerial deployment means is shown in FIGS. 19A to 19C. Said modified lower stopping and fastening means (9) comprise a transversal rod or pin (901) having two ends (9011, 9012), a fixed end piece (902) secured to the floor (11) of the vehicle and a mobile end piece (903) secured to the floor (11) of the vehicle. The end (9011) of the rod (901) is rotatably connected to the fixed end piece (902) by means of a ball-and-socket joint (904). This secures the end (9011) of said rod (901) to the bottom of the floor (11) of the vehicle, but allows it to have limited rotation. The rod (901) comprises an inner spring (905) which keeps the rod (901) parallel to the floor (11) of the vehicle and preventing rotation of the same when no external force is applied to it. The mobile end piece (903) is movable between a vertical position and an angled position, and comprises a transversal hole (909) or orifice which can engage the end (9012) of the rod when in vertical position. The position of the mobile end piece (903) is controlled by a lever (906), rotatably secured to the floor (11) of the vehicle. A cable (907) connects an end of the lever (906) to the rear fastening point (16) by means of a pulley system (not shown). A spring (908) connects the lever (906) to the floor (11) of the vehicle and applies a force on the lever (906) which holds the mobile end piece (903) connected to the lever (906) in vertical position.

The modified lower stopping and fastening means (9) may adopt three configurations or positions, which are described below. Since the modified lower stopping and fastening means (9) of only the upper vehicle is used during the stacking and unstacking procedure, all references to the modified lower stopping and fastening means (9) and its components are in reference to those in the upper vehicle.

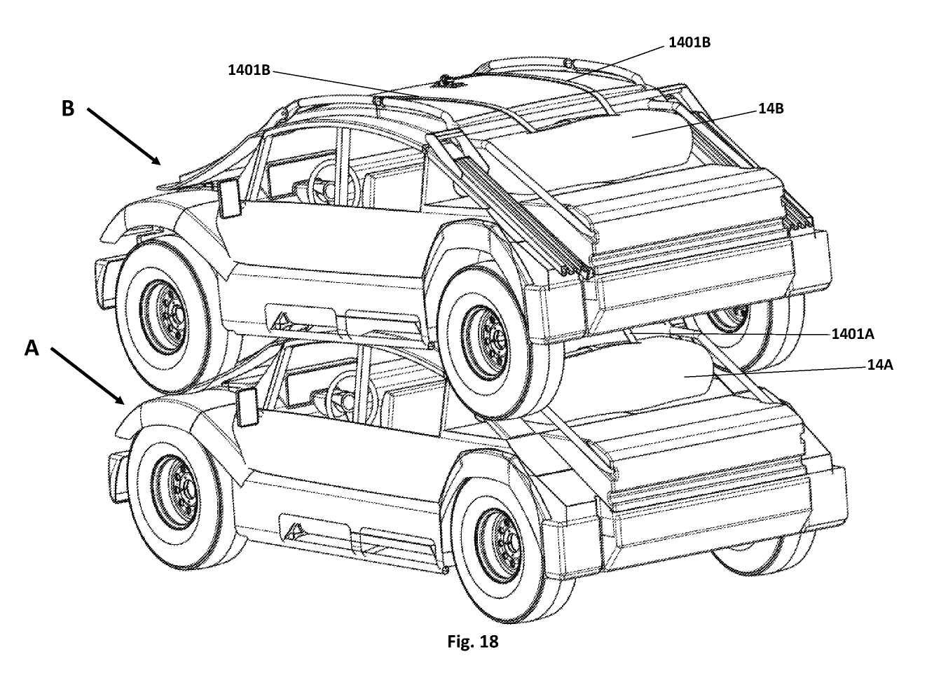

In a first position as shown in FIG. 19A, the mobile end piece (903) is in a vertical position and the end (9012) of the rod (901) non-rotatably engages the hole (909) of the mobile end piece (903), firmly securing the rod (901) in place by both ends and parallel to the floor (11) of the vehicle. While in this position, the modified lower stopping and fastening means (9) of the upper vehicle (B) can engage with the upper stopping and fastening means (10) of the lower vehicle (A) for stacking the upper vehicle (B) on top of the lower vehicle (A), according to the stacking method of the present invention previously described. FIG. 18 shows a stack of two vehicles, an upper vehicle (B) and a lower vehicle (A), both comprising the rapid aerial deployment means of the present invention, showing corresponding parachutes (14A, 14B) and corresponding front slings (1401A, 1401B). In said vehicle stack, the upper stopping and fastening means (not shown) of the lower vehicle (A) engage the modified lower stopping and fastening means (not shown) of the upper vehicle (B) in a manner identical to that of the stacking method of the present invention previously described. One or more of such vehicle stacks may then be loaded onto a transport aircraft, such as a transport airplane, for aerial deployment, and upon reaching an intended drop zone, one or more of such vehicles stacks may be dropped or launched by any known means of airdropping cargo. The vehicles are dropped off the transport plane in pairs, that is to say, both an upper vehicle (B) and a lower vehicle (A) are dropped off the plane while still in stacked configuration.

After being launched or dropped off the transport plane, the parachute (14B) of the upper vehicle (B) will be deployed by any means known in the art. When said parachute (14B) fully deploys, the sudden deceleration will create a pulling tension on the front slings (1401B) and the at least one rear sling (1402) of the parachute (14B) of the upper vehicle (B). Said pulling tension acting on the at least one rear sling (1402) of the parachute (14B) of the upper vehicle (B) will pull on the rear fastening point (not shown) of the upper vehicle (B) which, as previously mentioned, is connected to the lever (906) of the modified lower stopping and fastening means (9) of the upper vehicle (B) through the cable (907) and pulley system (not shown) of FIGS. 19A to 19C. Since this pulling tension on the lever (906) is greater than the force of the spring (908) holding the lever (906) in rest position, this will force lever (906) to rotate, which will consequently rotate the mobile end piece (903) from a vertical position to an angled position. When this happens, the end (9012) of the rod (901) will no longer be engaged and secured by the hole (909) of the mobile end piece (903), and the combination of the sudden deceleration of the upper vehicle and the weight of the lower vehicle pulling on the rod (901) will produce a force that exceeds the force of the inner spring (905) of the rod (901), causing it to rotate about its ball-and-socket joint (901). This is a second position of the modified lower stopping and fastening means (9) and is shown in FIG. 19B.

While in this second position of the modified lower stopping and fastening means (9), the space or clearing between the end (9012) of the rod (901) and the rotated mobile end piece (903) is large enough to allows the upper stopping, and fastening means (not shown) of the lower vehicle to disengage from the rod (901) of the modified lower stopping and fastening means (9) of the upper vehicle. The ball-and-socket joint (904) of the rod (901) allows for the modified lower stopping and fastening means (9) to disengage from the mobile end piece (903) in any direction, allowing for a safe disengagement of the vehicles even under misalignment or adverse condition which might affect the vehicle stack during the airdrop. The upper stopping and fastening means of the lower vehicle will thus slide off the rod (901) of the modified lower stopping and fastening means (9) of the upper vehicle, separating or unstacking both vehicles in the air. Without the weight of the lower vehicle pulling it down, and under the influence of its inner spring (905) the rod (901) of the upper vehicle will return to its original position. This is a third position of the modified lower stopping and fastening means (9) and is shown in FIG. 19C.

After disengaging from the upper vehicle, the parachute or breaking means of the lower vehicle will be deployed by any means known in the art. Both vehicles will land separately, and will be in full operational condition upon landing. Preferably, suitable disconnecting or disengaging means autonomously disconnect or disengage the parachutes of the vehicles upon landing, thereby preventing possible damages to the vehicles once on the ground. Once the parachutes disengage from the vehicle, the modified lower stopping and fastening means (9) of the vehicle, no longer under any pulling tension, will return to its first position.

While the invention has been illustrated and described in detail in the drawings and foregoing description, such illustration and description are to be considered illustrative or exemplary and not restrictive. The invention is not limited to the disclosed embodiments. Variations to the disclosed embodiments can be understood and affected by those skilled in the art in practicing the claimed disclosure, from a study of the drawings, the disclosure and the appended claims.

The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

1. A method for stacking a first motor vehicle on top of a second motor vehicle and forming a vehicle stack, the first and second motor vehicles being generally identical or similar and both vehicles generally comprising a vehicle body, front and rear wheels, front and rear fenders, a cabin, and a cabin roof, wherein the method comprises the steps of:
providing a set of rear ramps on a rear part of the first vehicle, linking a rear part of the roof of the cabin of the same with the ground, said rear ramps allowing the wheels of the second vehicle to roll on the them;
providing a set of front ramps on a front part of the roof of the first vehicle, said front ramps allowing the wheels of the second vehicle to roll and be supported by them;
rolling the second vehicle, oriented with the same or inverted orientation as the first vehicle, on said rear ramps so that it ascends from a position on the ground until it reaches the roof of the first vehicle;
continue the movement of the second vehicle on the roof of the first vehicle until it reaches a final position in which the front or rear wheels of the second vehicle, depending on whether the vehicles have the same or inverted orientation, are supported by the front ramps of the first vehicle, and the rear or front wheels of the second vehicle, depending on whether the vehicles have the same or inverted orientation, are supported by the rear ramps of the first vehicle, the final position of the wheels of the second vehicle resting at a height that is lower than the height of the roof of the first vehicle so that the total height of the second vehicle stacked on top of the first vehicle is lower than the sum of the individual heights of the first and second vehicles;
securing the second vehicle to the first vehicle by a fastening means; and
removing, folding, or collapsing part or the entirety of the rear ramps of the first vehicle.

2. The method according to claim 1, wherein in said final position the first vehicle and the second vehicle are substantially vertically aligned.

3. The method according to claim 1, wherein the second vehicle comprises suspensions and the fastening means partially compresses the suspensions of the second vehicle, reducing the total height of the vehicle stack.

4. The method according to claim 1, wherein said final position of the second vehicle is determined by stopping means.

5. The method according to claim 1, wherein the vehicle body of the first vehicle has an inner frontal structure and the front ramps rest upon resistant points in the frontal structure of the first vehicle.

6. The method according to claim 1, wherein the front ramps and the rear ramps are integral to the first vehicle.

7. A stackable vehicle for stacking on top of another identical or similar vehicle, for use with the method of claim 1, the vehicle comprising:
a vehicle body having an inner structure, a floor, four wheels, a roofed cabin;
a pair of rear ramps, which extend rearward, located at both sides of a rear end of the roof of the cabin; and
a pair of front ramps, which extend forward, located at both sides of a front end of the roof of the cabin.

8. The stackable vehicle according to claim 7, wherein the rear ramps are foldable ramps that can adopt at least a folded position and a deployed position, and when on deployed position the rear ramps rest upon the ground behind the vehicle.

9. The stackable vehicle according to claim 7, wherein the front ramps or supports are foldable ramps that can adopt at least a folded position and a deployed position, and when on deployed position the front ramps rest upon resistant points of inner structure of the vehicle.

10. The stackable vehicle according to claim 8, wherein the rear ramps each comprise a fixed part and a moving part, the fixed part of the rear ramps each having a rear end and a front end, the front ends of the fixed parts of the rear ramps being located at a rear end of the roof of the cabin of the vehicle and the rear ends of the fixed parts of the rear ramps are located at a rear end of the vehicle, thus linking the rear end of the roof of the cabin to the rear end of the vehicle, and the moving parts of the rear ramps are movingly connected to the rear ends of the corresponding fixed parts of the rear ramps.

11. The stackable vehicle according to claim 7, wherein at least a portion of the pair of rear ramps, or at least a portion of the pair of front ramps are removable.

12. The stackable vehicle according to claim 7, wherein the vehicle comprises an upper stopping and fastening means located on an upper part of the roof of the cabin, for securing a vehicle stacked on top of it, and a lower stopping and fastening means located on an external part of the floor of the vehicle for securing a vehicle stacked underneath it.

13. The stackable vehicle according to claim 12, wherein the lower stopping and fastening means comprises a transversal rod.

14. The stackable vehicle according to claim 12, wherein the upper stopping and fastening means comprises a hook type mechanism, actuated either automatically or by hand through a lever mechanism.

15. The stackable vehicle according to claim 12, wherein the upper stopping and fastening means comprise a bolt and nut system on an upper part of the roof of the cabin of the vehicle, actuated either automatically or by hand through a swivel mechanism.

16. The stackable vehicle according to claim 7, wherein the roof of the cabin is curved and convex.

17. The stackable vehicle according to claim 7, wherein the roof of the cabin is faceted and convex with descending angles on a front and a rear end.

18. The stackable vehicle according to claim 7, wherein the floor of the vehicle is curved and concave.

19. The stackable vehicle according to claim 7, wherein the roof of the cabin comprises two depressed or stepped regions or strips located one on each side of the roof, which run the entire length of the roof, for rolling the wheels of a second vehicle during a stacking operation, said depressed or stepped regions or strips being aligned with the front ramps and the rear ramps.

20. The stackable vehicle according to claim 7, wherein the roof of the cabin comprises a pair of tubular structures, one on each side of the roof and running the length of the same, delimiting side regions aligned with the front ramps or supports and the rear ramps, for guiding the movement of the wheels of a second vehicle during a stacking operation.

21. The stackable vehicle according to claim 12, wherein the vehicle further comprises:
a deployable slowing device, for slowing down a falling vehicle to a safe landing speed, having two front slings and at least one rear sling;
two front fastening points located on the front of the vehicle; and
a rear fastening point located behind the cabin of the vehicle;
each of the two front slings of the foldable slowing device being secured to a respective front fastening point, and the at least one rear sling is connected to the rear fastening point.

22. The stackable vehicle according to claim 21, wherein the deployable slowing device comprises at least one parachute.

23. The stackable vehicle according to claim 21, wherein the lower stopping and fastening means of the vehicle comprises:
a fixed end piece, secured to the floor of the vehicle;
a transversal rod or pin having a first end, a second ends and an inner spring, the rod being connected by the first end to said fixed end piece by means of a ball-and-socket joint;
a mobile end piece, secured to the floor of the vehicle, connected to a lever and having a transversal hole;
a spring, connecting an end of the lever to floor of the vehicle and applying force to said lever; and
a cable, connecting said end of the lever to said rear fastening point through a pulley system;
the mobile end piece being able to adopt at least a vertical position and at least an angled position;
the inner spring of the rod keeping the rod parallel to the floor of the vehicle when no external force is applied to the rod;
the force of the spring acting on the lever keeping the mobile end piece in vertical position;
the second end of the rod being able to engage with the transversal hole of the mobile end piece when the mobile end piece is in vertical position; so that
a pulling force greater than the force of the spring applied on the rear fastening point causes the cable to pull on the lever causing it to rotate thereby causing the mobile end piece connected to the lever to rotate from the vertical position to the angled position; and
a force applied to the rod that exceeds the force of the inner spring of the rod while the mobile end piece is in angled position causes the rod to rotate about the ball-and-socket joint of its first end.

24. A method for rapid aerial deployment of stackable vehicles, wherein the method comprises:
forming at least one vehicle stack according a method comprising providing a set of rear ramps on a rear part of the first vehicle, linking a rear part of the roof of the cabin of the same with the ground, said rear ramps allowing the wheels of the second vehicle to roll on the them;
providing a set of front ramps on a front part of the roof of the first vehicle, said front ramps allowing the wheels of the second vehicle to roll and be supported by them;
rolling the second vehicle, oriented with the same or inverted orientation as the first vehicle, on said rear ramps so that it ascends from a position on the ground until it reaches the roof of the first vehicle;
continue the movement of the second vehicle on the roof of the first vehicle until it reaches a final position in which the front or rear wheels of the second vehicle, depending on whether the vehicles have the same or inverted orientation, are supported by the front ramps of the first vehicle, and the rear or front wheels of the second vehicle, depending on whether the vehicles have the same or inverted orientation, are supported by the rear ramps of the first vehicle, the final position of the wheels of the second vehicle resting at a height that is lower than the height of the roof of the first vehicle so that the total height of the second vehicle stacked on top of the first vehicle is lower than the sum of the individual heights of the first and second vehicles;
securing the second vehicle to the first vehicle by a fastening means; and
removing, folding, or collapsing part or the entirety of the rear ramps of the first vehicle by stacking a first motor vehicle and a second motor vehicle according to claim 23,
wherein the first motor vehicle is stacked on top of the second motor vehicle,
loading the at least one vehicle stack onto a transport aircraft,
upon reaching an intended drop zone with the transport aircraft, launching or dropping the at least one vehicle stack off the transport aircraft,
wherein
after being launched or dropped off the transport plane, the deployable slowing device of the first vehicle is deployed, thereby decelerating the first vehicle to a safe landing speed,
and wherein the deceleration of the first vehicle creates a pulling force on the rear fastening point of the first vehicle which is greater than the force of the spring of the lower stopping and fastening means of the first vehicle, thereby causing the mobile end piece of the lower stopping and fastening means of the first vehicle to rotate from a vertical position to an angled position, and where the combination of the deceleration of the first vehicle and the weight of the second vehicle apply a force to the rod of the lower stopping and fastening means of the first vehicle that exceeds the force of the inner spring of said rod, thereby causing the rod to rotate about its ball-and-socket joint on its first end, and
wherein
the clearing between the rotated rod and the rotated mobile end piece is large enough to allow the upper stopping and fastening means of the second vehicle to disengage from the rod, and wherein after disengaging from the first vehicle, the deployable slowing device of the second vehicle is deployed, thereby decelerating the first vehicle to a safe landing speed.
